(19) United States
(12) Patent Application Publication
(10) Pub. No.: US 2025/0105250 A1
(43) Pub. Date: Mar. 27, 2025

(54) SECONDARY BATTERY AND BATTERY PACK

(71) Applicant: MURATA MANUFACTURING CO., LTD., Kyoto (JP)

(72) Inventors: Toshikazu NAKAMURA, Kyoto (JP); Kei WAKABAYASHI, Kyoto (JP); Yosuke KAIHARA, Kyoto (JP); Yukihiro OKAMOTO, Kyoto (JP)

(21) Appl. No.: 18/896,010

(22) Filed: Sep. 25, 2024

(30) Foreign Application Priority Data
Sep. 27, 2023 (JP) 2023-165908

(51) Int. Cl. H01M 4/13; H01M 10/0525; H01M 10/0587; H01M 10/42; H01M 50/107

(52) U.S. Cl. CPC H01M 4/13; H01M 10/0525; H01M 10/0587; H01M 10/425; H01M 50/107

(57) ABSTRACT

A secondary battery includes a stacked body including a positive electrode, a negative electrode, and a separator. The positive electrode includes a positive electrode active material layer, a positive electrode current collector, and an insulating layer. The positive electrode current collector includes a positive electrode covered region and a positive electrode exposed region. The positive electrode exposed region is not covered with the positive electrode active material layer and extends in a width direction from the positive electrode active material layer. The insulating layer extends along a first edge of the positive electrode active material layer. The first edge is located at a border between the positive electrode covered region and the positive electrode exposed region. The positive electrode active material layer includes a first thin part and a first thick part that is adjacent to the first thin part in the width direction.

### CROSS-REFERENCE TO RELATED APPLICATIONS

The present application claims priority from Japanese Patent Application No. 2023-165908 filed on Sep. 27, 2023, the entire contents of which are hereby incorporated by reference.

### BACKGROUND

The present disclosure relates to a secondary battery, and to a battery pack that includes the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

For example, a secondary battery is disclosed in which what is called a tabless structure is employed. Such a secondary battery achieves a reduced internal resistance and allows for charging and discharging with a relatively large current.

### SUMMARY

A secondary battery according to an embodiment of the present disclosure includes an electrode wound body and an outer package can. The electrode wound body includes a stacked body and has a through hole. The stacked body includes a positive electrode, a negative electrode, and a separator and is wound along a longitudinal direction of the stacked body.

The through hole is provided through the electrode wound body in a width direction orthogonal to the longitudinal direction. The outer package can contains the electrode wound body. The positive electrode includes a positive electrode active material layer, a positive electrode current collector, and an insulating layer. The positive electrode active material layer extends in both the longitudinal direction and the width direction. The positive electrode current collector includes a positive electrode covered region and a positive electrode exposed region. The positive electrode covered region is covered with the positive electrode active material layer. The positive electrode exposed region is not covered with the positive electrode active material layer and extends in the width direction from the positive electrode active material layer.

The insulating layer extends in the longitudinal direction along a first edge of the positive electrode active material layer. The first edge is located at a border between the positive electrode covered region and the positive electrode exposed region. The positive electrode active material layer includes a first thin part and a first thick part. The first thick part has a thickness greater than a thickness of the first thin part and is adjacent to the first thin part in the width direction.

A battery pack according to an embodiment of the present disclosure includes a secondary battery, a processor, and an outer package body. The processor is configured to control the secondary battery. The outer package body contains the secondary battery. The secondary battery includes an electrode wound body and an outer package can. The electrode wound body includes a stacked body and has a through hole. The stacked body includes a positive electrode, a negative electrode, and a separator and is wound along a longitudinal direction of the stacked body. The through hole is provided through the electrode wound body in a width direction orthogonal to the longitudinal direction. The outer package can contains the electrode wound body. The positive electrode includes a positive electrode active material layer, a positive electrode current collector, and an insulating layer. The positive electrode active material layer extends in both the longitudinal direction and the width direction. The positive electrode current collector includes a positive electrode covered region and a positive electrode exposed region. The positive electrode covered region is covered with the positive electrode active material layer. The positive electrode exposed region is not covered with the positive electrode active material layer and extends in the width direction from the positive electrode active material layer. The insulating layer extends in the longitudinal direction along a first edge of the positive electrode active material layer. The first edge is located at a border between the positive electrode covered region and the positive electrode exposed region. The positive electrode active material layer includes a first thin part and a first thick part. The first thick part has a thickness greater than a thickness of the first thin part and is adjacent to the first thin part in the width direction.

### BRIEF DESCRIPTION OF THE FIGURES

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a sectional diagram illustrating a configuration example of a vertical sectional structure of a secondary battery according to an embodiment of the present disclosure along a height direction.

FIG. 2 is a schematic diagram illustrating a configuration example of a stacked body including a positive electrode, a negative electrode, and a separator illustrated in FIG. 1.

FIG. 3 is a sectional diagram illustrating a configuration example of a horizontal sectional structure of an electrode wound body illustrated in FIG. 1.

FIG. 4A is a developed view of the positive electrode illustrated in FIG. 1.

FIG. 4B is a first sectional view of the positive electrode illustrated in FIG. 1.

FIG. 4C is a second sectional view of the positive electrode illustrated in FIG. 1.

FIG. 5A is a developed view of the negative electrode illustrated in FIG. 1.

FIG. 5B is a sectional view of the negative electrode illustrated in FIG. 1.

FIG. 6A is a plan view of a positive electrode current collector plate illustrated in FIG. 1.

FIG. 6B is a plan view of a negative electrode current collector plate illustrated in FIG. 1.

FIGS. 7A to 7F are each a perspective diagram describing a process of manufacturing the secondary battery illustrated in FIG. 1.

FIG. 8 is a block diagram illustrating a circuit configuration of a battery pack to which the secondary battery according to an embodiment of the present disclosure is applied.

FIG. 9 is a sectional view of a positive electrode according to a first modification example of an embodiment of the present disclosure.

FIG. 10A is a sectional diagram illustrating a first example of a positive electrode according to a second modification example of an embodiment of the present disclosure.

FIG. 10B is a sectional diagram illustrating a second example of the positive electrode according to the second modification example of an embodiment of the present disclosure.

FIG. 10C is a sectional diagram illustrating a third example of the positive electrode according to the second modification example of an embodiment of the present disclosure.

FIG. 11A is a developed view of a positive electrode according to a third modification example of an embodiment of the present disclosure.

FIG. 11B is a sectional view of the positive electrode illustrated in FIG. 11A.

FIG. 12A is a developed view of a positive electrode of Example 1-1.

FIG. 12B is a sectional view of the positive electrode of Example 1-1.

FIG. 13A is a developed view of a positive electrode of each of Examples 1-2 to 1-5.

FIG. 13B is a sectional view of the positive electrode of each of Examples 1-2 to 1-5.

FIG. 14A is a developed view of a positive electrode of each of Examples 1-6 to 1-9.

FIG. 14B is a sectional view of the positive electrode of each of Examples 1-6 to 1-9.

FIG. 15 is a sectional view of a positive electrode of Example 3-1.

### DETAILED DESCRIPTION

Consideration has been given in various ways to improve performance of a secondary battery. However, there is still room for improvement in reliability of the secondary battery.

It is desirable to provide a secondary battery that is superior in reliability, and to provide a battery pack that includes such a secondary battery.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an embodiment of the present disclosure.

In an embodiment, a cylindrical lithium-ion secondary battery having an outer appearance of a cylindrical shape will be described as an example. However, a secondary battery of an embodiment of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery may include a positive electrode, a negative electrode, and an electrolyte. In the secondary battery, to prevent precipitation of the electrode reactant on a surface of the negative electrode during charging, a charge capacity of the negative electrode may be greater than a discharge capacity of the positive electrode. For example, an electrochemical capacity per unit area of the negative electrode may be set to be greater than an electrochemical capacity per unit area of the positive electrode.

The electrode reactant is not particularly limited in kind, as described above. For example, the electrode reactant may be a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

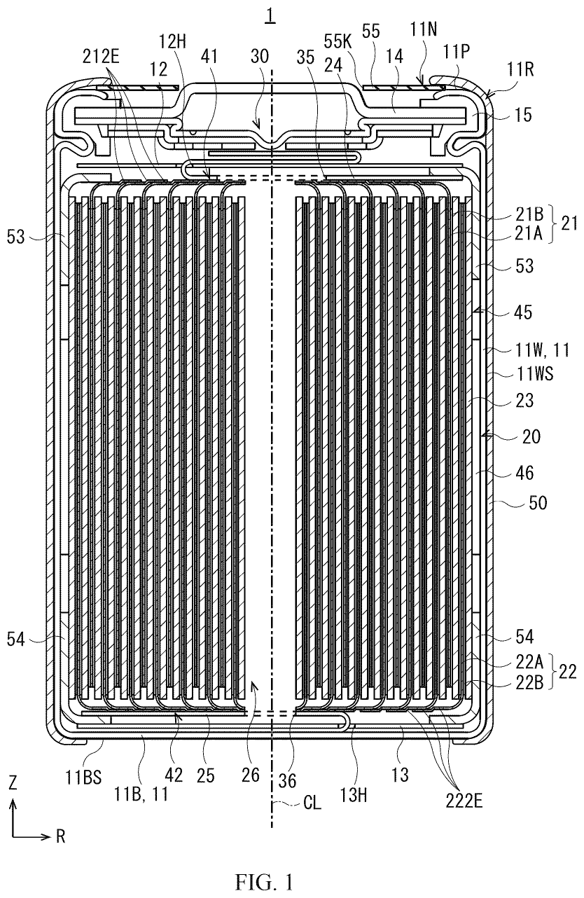

FIG. 1 illustrates a vertical sectional configuration of a lithium-ion secondary battery 1 according to an embodiment along a height direction. The lithium-ion secondary battery 1 according to an embodiment is hereinafter simply referred to as the “secondary battery 1”. The secondary battery 1 illustrated in FIG. 1 includes an outer package can 11 and an electrode wound body 20. The outer package can 11 may have a substantially cylindrical shape. The electrode wound body 20 is contained inside the outer package can 11 and may serve as a battery device. The secondary battery 1 may further include an outer package tube 50. The outer package tube 50 may cover an outer peripheral surface of the outer package can 11. Note that, herein, the height direction of the secondary battery 1 corresponds to a Z-axis direction.

For example, the secondary battery 1 may include, inside the outer package can 11, a pair of insulating plates 12 and 13, the electrode wound body 20, a positive electrode current collector plate 24, and a negative electrode current collector plate 25. The electrode wound body 20 may be a structure in which a positive electrode 21 and a negative electrode 22 are stacked on each other with a separator 23 interposed therebetween and are wound, for example. The electrode wound body 20 may be impregnated with an electrolytic solution. The electrolytic solution may be a liquid electrolyte. In an embodiment, the secondary battery 1 may further include a thermosensitive resistive device, a reinforcing member, or both inside the outer package can 11. Non-limiting examples of the thermosensitive resistive device may include a positive temperature coefficient (PTC) device.

The outer package can 11 may contain components including, without limitation, the positive electrode current collector plate 24, the negative electrode current collector plate 25, and the electrode wound body 20. In an embodiment, the outer package can 11 may include a bottom part 11B and a sidewall part 11W. The bottom part 11B may also serve as a negative electrode terminal coupled to the negative electrode 22 via the negative electrode current collector plate 25. The outer package can 11 may have, for example, a hollow cylindrical structure having a lower end part and an upper end part in the Z-axis direction. The lower end part may be closed, and the upper end part may be open. The upper end part of the outer package can 11 may thus be an open end part 11N. The lower end part of the outer package can 11 may be closed by the bottom part 11B having a substantially circular plate shape. The sidewall part 11W may be provided between the open end part 11N and the bottom part 11B and may surround the electrode wound body 20. The sidewall part 11W may so stand in the height direction, i.e., a width direction of the electrode wound body 20, and along an outer edge of the bottom part 11B as to surround the electrode wound body 20. The sidewall part 11W may include the open end part 11N on an opposite side to the bottom part 11B. The open end part 11N may be open to allow the electrode wound body 20 to be passed therethrough. The outer package can 11 may include, for example, a metal material such as iron. In an embodiment, a surface of the outer package can 11 may be plated with a metal material such as nickel. The insulating plate 12 and the insulating plate 13 may be so opposed to each other as to allow the electrode wound body 20 to be interposed therebetween in the Z-axis direction, for example. Note that, herein, the open end part 11N and the vicinity thereof in the Z-axis direction may be referred to as an upper part of the secondary battery 1, and a region where the outer package can 11 is closed and the vicinity thereof in the Z-axis direction may be referred to as a lower part of the secondary battery 1. The sidewall part 11W may correspond to a specific but non-limiting example of a “wall part” in an embodiment of the present disclosure.

The outer package tube 50 may surround a side surface 11WS that is an outer surface of the sidewall part 11W of the outer package can 11. In an embodiment, the outer package tube 50 may cover a bent part 11P positioned at the upper end part of the outer package can 11, as illustrated in FIG. 1. The bent part 11P will be described later. In an embodiment, the outer package tube 50 may cover a portion of a bottom surface 11BS that is an outer surface of the bottom part 11B of the outer package can 11. The outer package tube 50 may include, for example, a thermally contractible insulating film that includes a material such as a polyester-based resin, a polyamide-based resin, or a thermoplastic elastomer resin.

A washer 55 may be provided in a gap between the outer package tube 50 and the bent part 11P of the outer package can 11. The washer 55 may be an insulating ring member that has an opening 55K in a middle region in a plane orthogonal to the height direction. Disposed in the opening 55K may be a projecting part provided in a middle region of a battery cover 14. The washer 55 may include a material such as black modified polyphenylene ether.

Each of the insulating plates 12 and 13 may be, for example, a dish-shaped plate having a surface perpendicular to a central axis CL of the electrode wound body 20, that is, a surface perpendicular to a Z-axis in FIG. 1. The insulating plates 12 and 13 may be so disposed as to allow the electrode wound body 20 to be interposed therebetween.

For example, a structure in which the battery cover 14 and a safety valve mechanism 30 are crimped with a gasket 15 interposed therebetween, that is, a crimped structure 11R, may be provided at the open end part 11N of the outer package can 11. The outer package can 11 may be sealed by the battery cover 14, with the electrode wound body 20 and other components being contained inside the outer package can 11. The crimped structure 11R may include the bent part 11P serving as what is called a crimped part.

The battery cover 14 may be a closing member that closes the open end part 11N in a state where the electrode wound body 20 and other components are contained inside the outer package can 11, for example. The battery cover 14 may be, for example, an electrical conductor that includes a material similar to the material included in the outer package can 11. In an embodiment, the battery cover 14 may close the open end part 11N of the outer package can 11 and may be coupled to the positive electrode current collector plate 24. Therefore, the battery cover 14 may also serve as a positive electrode terminal coupled to the positive electrode 21 via the positive electrode current collector plate 24. The middle region of the battery cover 14 may protrude upward, i.e., in a +Z direction, for example. As a result, a peripheral region, i.e., a region other than the middle region, of the battery cover 14 may be in contact with the safety valve mechanism 30, for example. The battery cover 14 may correspond to a specific but non-limiting example of a “cover part” in an embodiment of the present disclosure.

The gasket 15 may be a sealing member interposed between the bent part 11P of the outer package can 11 and the battery cover 14, for example. The gasket 15 may seal a gap between the bent part 11P and the battery cover 14. In an embodiment, a surface of the gasket 15 may be coated with a material such as asphalt. The gasket 15 may include any one or more of insulating materials, for example. The insulating material is not particularly limited in kind, and non-limiting examples thereof may include a polymer material such as polybutylene terephthalate (PBT) or polypropylene (PP). In an embodiment, the insulating material may be polybutylene terephthalate. One reason for this is that this helps to allow for sufficient sealing of the gap between the bent part 11P and the battery cover 14, with the outer package can 11 and the battery cover 14 being electrically separated from each other.

The safety valve mechanism 30 may be adapted to cancel the sealed state of the outer package can 11 to thereby release a pressure inside the outer package can 11, i.e., an internal pressure of the outer package can 11, on an as-needed basis upon an increase in the internal pressure of the outer package can 11, for example. Non-limiting examples of a cause of the increase in the internal pressure of the outer package can 11 may include a gas generated due to a decomposition reaction of the electrolytic solution upon charging and discharging. The internal pressure of the outer package can 11 can also increase due to heating from outside.

The electrode wound body 20 may be disposed between the positive electrode current collector plate 24 and the negative electrode current collector plate 25. In an embodiment, the electrode wound body 20 may have an upper end face 41 and a lower end face 42. The upper end face 41 may face the positive electrode current collector plate 24 in the height direction, i.e., the width direction of the electrode wound body 20. The lower end face 42 may face the negative electrode current collector plate 25 in the height direction. The electrode wound body 20 may be a power generation device that causes charging and discharging reactions to proceed, and is contained inside the outer package can 11. The electrode wound body 20 may include the positive electrode 21, the negative electrode 22, the separator 23, and the electrolytic solution, i.e., a liquid electrolyte. The upper end face 41 may correspond to a specific but non-limiting example of a “first end face” in an embodiment of the present disclosure. The lower end face 42 may correspond to a specific but non-limiting example of a “second end face” in an embodiment of the present disclosure.

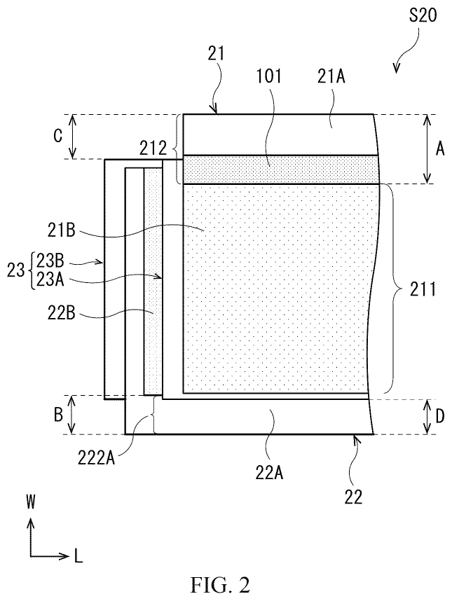

FIG. 2 is a developed view of the electrode wound body 20, and schematically illustrates a portion of a stacked body S20. The stacked body S20 includes the positive electrode 21, the negative electrode 22, and the separator 23. In the stacked body S20 corresponding to the electrode wound body 20 in an unwound state, the positive electrode 21 and the negative electrode 22 may be stacked on each other with the separator 23 interposed therebetween. The separator 23 may include, for example, two bases, i.e., a first separator member 23A and a second separator member 23B. The electrode wound body 20 may thus include the stacked body S20 that is four-layered. In the four-layered stacked body S20, the positive electrode 21, the first separator member 23A, the negative electrode 22, and the second separator member 23B may be stacked in order. Each of the positive electrode 21, the first separator member 23A, the negative electrode 22, and the second separator member 23B may be a substantially band-shaped member in which a W direction corresponds to a transverse direction and an L direction corresponds to a longitudinal direction.

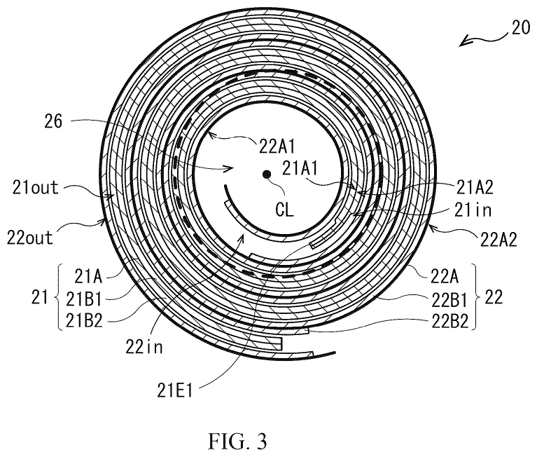

As illustrated in FIG. 3, the electrode wound body 20 may be the stacked body S20 so wound around a through hole 26 that extends along the central axis CL extending in the Z-axis direction as to form a spiral shape in a horizontal section orthogonal to the Z-axis direction. Here, the stacked body S20 may be wound in an orientation in which the W direction substantially coincides with the Z-axis direction. Note that FIG. 3 illustrates a configuration example of the electrode wound body 20, along the horizontal section orthogonal to the Z-axis direction. Note that, for higher visibility, FIG. 3 omits illustration of the separator 23. The electrode wound body 20 may have an outer appearance of a substantially circular columnar shape as a whole. The positive electrode 21 and the negative electrode 22 may be wound, remaining in a state of being opposed to each other with the separator 23 interposed therebetween. The electrode wound body 20 may have the through hole 26 as an internal space at a center thereof. The through hole 26 may be a hole into which a winding core for assembling the electrode wound body 20 and an electrode rod for welding are each to be put. The through hole 26 may extend in the Z-axis direction along the central axis CL, and is provided through the electrode wound body 20. The stacked body S20 may thus be wound around the through hole 26.

The positive electrode 21, the negative electrode 22, and the separator 23 may be so wound that the separator 23 is positioned in each of an outermost wind of the electrode wound body 20 and an innermost wind of the electrode wound body 20. In the outermost wind of the electrode wound body 20, the negative electrode 22 may be positioned on an outer side relative to the positive electrode 21. For example, as illustrated in FIG. 3, an outermost wind part 21out of the positive electrode 21 positioned in an outermost wind of the positive electrode 21 included in the electrode wound body 20 may be positioned on an inner side relative to an outermost wind part 22out of the negative electrode 22 positioned in an outermost wind of the negative electrode 22 included in the electrode wound body 20. Here, the outermost wind part 21out of the positive electrode 21 may be a part corresponding to the outermost one wind of the positive electrode 21 in the electrode wound body 20. The outermost wind part 22out of the negative electrode 22 may be a part corresponding to the outermost one wind of the negative electrode 22 in the electrode wound body 20. In contrast, in the innermost wind of the electrode wound body 20, the negative electrode 22 may be positioned on the inner side relative to the positive electrode 21. For example, as illustrated in FIG. 3, an innermost wind part 22 in of the negative electrode 22 positioned in an innermost wind of the negative electrode 22 included in the electrode wound body 20 may be positioned on the inner side relative to an innermost wind part 21 in of the positive electrode 21 positioned in an innermost wind of the positive electrode 21 included in the electrode wound body 20. Here, the innermost wind part 21 in of the positive electrode 21 may be a part corresponding to the innermost one wind of the positive electrode 21 in the electrode wound body 20. The innermost wind part 22 in of the negative electrode 22 may be a part corresponding to the innermost one wind of the negative electrode 22 in the electrode wound body 20. The number of winds of each of the positive electrode 21, the negative electrode 22, and the separator 23 is not particularly limited, and may be chosen as desired.

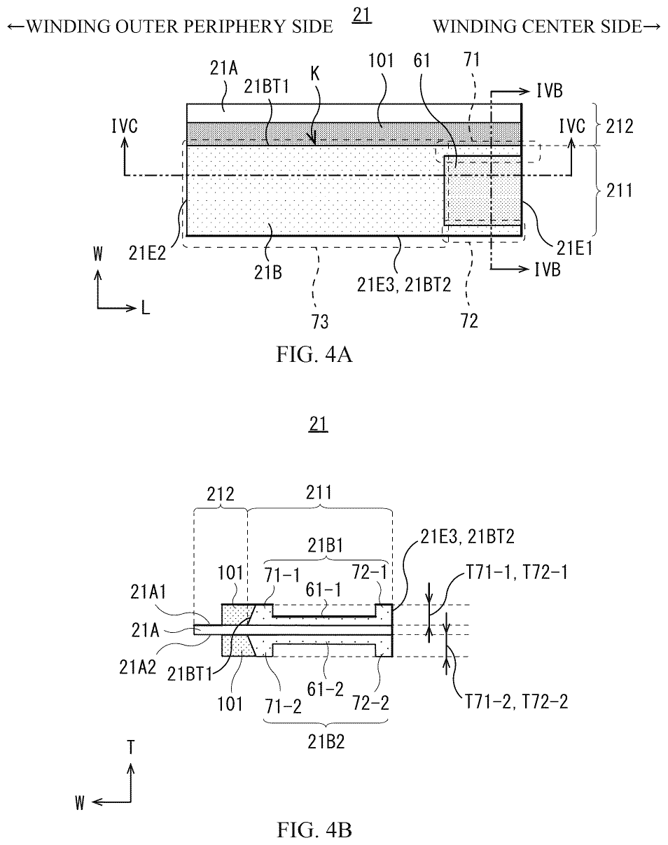

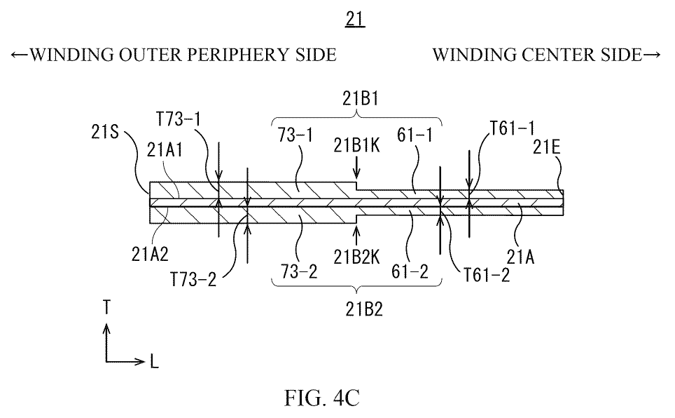

FIG. 4A is a developed view of the positive electrode 21, and schematically illustrates a state before being wound. FIGS. 4B and 4C each illustrate a sectional configuration of the positive electrode 21. Note that FIG. 4B illustrates a section as viewed in an arrowed direction along a line IVB-IVB illustrated in FIG. 4A. FIG. 4C illustrates a section as viewed in an arrowed direction along a line IVC-IVC illustrated in FIG. 4A. The positive electrode 21 includes a positive electrode current collector 21A, a positive electrode active material layer 21B, and an insulating layer 101. The positive electrode active material layer 21B may be provided simply on one of two opposite surfaces of the positive electrode current collector 21A, or may be provided on each of the two opposite surfaces of the positive electrode current collector 21A, for example. FIG. 4B illustrates an example case where the positive electrode active material layer 21B is provided on each of the two opposite surfaces of the positive electrode current collector 21A. In an embodiment, the positive electrode current collector 21A may include an inward surface 21A1 facing toward the central axis CL, and an outward surface 21A2 positioned on an opposite side to the inward surface 21A1. In an embodiment, the positive electrode 21 may include an inner winding side positive electrode active material layer 21B1 and an outer winding side positive electrode active material layer 21B2, as the positive electrode active material layers 21B. The inner winding side positive electrode active material layer 21B1 may cover all or a part of the inward surface 21A1 of the positive electrode current collector 21A. The outer winding side positive electrode active material layer 21B2 may cover all or a part of the outward surface 21A2 of the positive electrode current collector 21A. Herein, the inner winding side positive electrode active material layer 21B1 and the outer winding side positive electrode active material layer 21B2 may each be generically referred to as the positive electrode active material layer 21B, without being distinguished from each other. The positive electrode active material layer 21B extends in both the L direction and the W direction orthogonal to the L direction. The L direction corresponds to a longitudinal direction of the positive electrode 21. The W direction corresponds to a width direction of the positive electrode 21. The L direction corresponds to a winding direction of the stacked body S20. The W direction substantially coincides with the central axis CL. The inner winding side positive electrode active material layer 21B1 may correspond to a specific but non-limiting example of a “first positive electrode active material layer” in an embodiment of the present disclosure. The outer winding side positive electrode active material layer 21B2 may correspond to a specific but non-limiting example of a “second positive electrode active material layer” in an embodiment of the present disclosure.

The positive electrode current collector 21A includes a positive electrode covered region 211 and a positive electrode exposed region 212. The positive electrode covered region 211 is covered with the positive electrode active material layer 21B. The positive electrode exposed region 212 is not covered with the positive electrode active material layer 21B and extends in the W direction. The insulating layer 101 extends in the L direction and along a first edge 21BT1 of the positive electrode active material layer 21B. The first edge 21BT1 is positioned at a border K between the positive electrode covered region 211 and the positive electrode exposed region 212. Note that in the positive electrode 21 of an embodiment, the first edge 21BT1 of the positive electrode active material layer 21B may be a part of an inclined surface, and the insulating layer 101 may be in contact with the first edge 21BT1, as illustrated in FIG. 4B. For example, the insulating layer 101 may cover the first edge 21BT1 of the positive electrode active material layer 21B and the vicinity thereof. The positive electrode active material layer 21B includes a thin part 61 and a thick part 71. In an embodiment, the positive electrode active material layer 21B may further include thick parts 72 and 73. In the positive electrode 21 of an embodiment, each of the thin part 61 and the thick parts 71 to 73 may be provided on each of the inward surface 21A1 and the outward surface 21A2 of the positive electrode current collector 21A. In other words, each of the inner winding side positive electrode active material layer 21B1 and the outer winding side positive electrode active material layer 21B2 may include each of the thin part 61 and the thick parts 71 to 73. In an embodiment, however, in the positive electrode 21, at least either the inner winding side positive electrode active material layer 21B1 or the outer winding side positive electrode active material layer 21B2 may include the thin part 61 and the thick parts 71 to 73. Note that, for convenience, in FIGS. 4B and 4C, the thin part 61 and the thick parts 71, 72, and 73 included in the inner winding side positive electrode active material layer 21B1 are respectively denoted as a thin part 61-1 and thick parts 71-1, 72-1, and 73-1; and the thin part 61 and the thick parts 71, 72, and 73 included in the outer winding side positive electrode active material layer 21B2 are respectively denoted as a thin part 61-2 and thick parts 71-2, 72-2, and 73-2. Further, in an embodiment illustrated in FIG. 4C, a position of a border 21B1K between the thin part 61-1 and the thick part 73-1 in the L direction may substantially coincide with a position of a border 21B2K between the thin part 61-2 and the thick part 73-2 in the L direction. The thin part 61 may correspond to a specific but non-limiting example of a “first thin part” in an embodiment of the present disclosure. The thick part 71 may correspond to a specific but non-limiting example of a “first thick part” in an embodiment of the present disclosure. The thick part 72 may correspond to a specific but non-limiting example of a “second thick part” in an embodiment of the present disclosure. The thick part 73 may correspond to a specific but non-limiting example of a “third thick part” in an embodiment of the present disclosure. The border 21B1K may correspond to a specific but non-limiting example of a “first border” in an embodiment of the present disclosure. The border 21B2K may correspond to a specific but non-limiting example of a “second border” in an embodiment of the present disclosure.

The thick part 71 has a thickness greater than a thickness of the thin part 61. In an embodiment, each of the thick parts 72 and 73 may have a thickness greater than the thickness of the thin part 61. For example, the thickness of the thin part 61 may be about half the thickness of each of the thick parts 71 to 73. The respective thicknesses of the thick parts 71 to 73 may be equal to each other, or may be different from each other. For example, as illustrated in each of FIGS. 4B and 4C, in the inner winding side positive electrode active material layer 21B1, each of a thickness T71-1 of the thick part 71-1, a thickness T72-1 of the thick part 72-1, and a thickness T73-1 of the thick part 73-1 may be greater than a thickness T61-1 of the thin part 61-1. Note that in an embodiment illustrated in each of FIGS. 4B and 4C, the thickness T71-1 of the thick part 71-1, the thickness T72-1 of the thick part 72-1, and the thickness T73-1 of the thick part 73-1 may be equal to each other. Similarly, in the outer winding side positive electrode active material layer 21B2, each of a thickness T71-2 of the thick part 71-2, a thickness T72-2 of the thick part 72-2, and a thickness T73-2 of the thick part 73-2 may be greater than a thickness T61-2 of the thin part 61-2. Note that in an embodiment illustrated in each of FIGS. 4B and 4C, the thickness T71-2 of the thick part 71-2, the thickness T72-2 of the thick part 72-2, and the thickness T73-2 of the thick part 73-2 may be equal to each other. The thickness T61-1 and the thickness T61-2 may be equal to each other, or may be different from each other. The thickness T71-1 and the thickness T71-2 may be equal to each other, or may be different from each other. The thickness T72-1 and the thickness T72-2 may be equal to each other, or may be different from each other. The thickness T73-1 and the thickness T73-2 may be equal to each other, or may be different from each other. In addition, a length of the thick part 73 may be greater than a length of each of the thick parts 71 and 72 in the width direction of the positive electrode 21.

In an embodiment, the thin part 61 may include a winding center side edge 21E1 of the positive electrode 21, i.e., an edge of the positive electrode 21 on a winding center side in the L direction. In an embodiment, the thin part 61 may have a length in the L direction that corresponds to, for example, about one wind to about five winds of the electrode wound body 20 from the winding center side edge 21E1. The thick part 71 is adjacent to the thin part 61 in the W direction. In an embodiment, the thick part 71 may be positioned between the thin part 61 and the insulating layer 101 in the W direction. In an embodiment, the thick part 71 may include the first edge 21BT1 and may be in contact with the insulating layer 101. The thick part 72 may include a second edge 21BT2 positioned on an opposite side to the first edge 21BT1 in the W direction. The thick part 73 may be positioned on an opposite side of the thin part 61 to the winding center side edge 21E1 in the L direction. In an embodiment, the thick parts 71 to 73 may be separated from each other. In an embodiment, all or a part of the thick parts 71 to 73 may be integrated with each other. Each of the thick parts 71 and 72 may include the winding center side edge 21E1 of the positive electrode 21 in the L direction.

As illustrated in FIG. 4A, the positive electrode covered region 211 and the positive electrode exposed region 212 may each extend along the L direction from the winding center side edge 21E1 of the positive electrode 21 to a winding outer periphery side edge 21E2 of the positive electrode 21, i.e., an edge of the positive electrode 21 on a winding outer periphery side in the L direction, of the positive electrode 21. In other words, in the positive electrode 21, the positive electrode current collector 21A may be covered with the positive electrode active material layer 21B from the winding center side edge 21E1 of the positive electrode 21 to the winding outer periphery side edge 21E2 of the positive electrode 21 in the winding direction of the electrode wound body 20. The positive electrode covered region 211 and the positive electrode exposed region 212 may be adjacent to each other in the W direction. Note that FIGS. 4A and 4B each schematically illustrate the positive electrode current collector 21A in a straightened state along the W direction. In actuality, however, as illustrated in FIG. 1, a positive electrode edge part 212E of the positive electrode exposed region 212 may be bent toward the central axis CL and may be coupled to the positive electrode current collector plate 24. In an embodiment, an end part of the positive electrode exposed region 212 in the W direction may form the upper end face 41 and may be coupled to the positive electrode current collector plate 24, as illustrated in FIG. 1. In an embodiment, the upper end face 41 may include the positive electrode edge part 212E, of the positive electrode exposed region 212, that is bent toward the through hole 26 in a state where the stacked body S20 is wound.

In an embodiment, the insulating layer 101 may be provided in a region including the border K between the positive electrode covered region 211 and the positive electrode exposed region 212 and the vicinity of the border K. In an embodiment, as with the positive electrode covered region 211 and the positive electrode exposed region 212, the insulating layer 101 may also extend from the winding center side edge 21E1 to the winding outer periphery side edge 21E2 in the electrode wound body 20. In an embodiment, the insulating layer 101 may be adhered to the first separator member 23A, the second separator member 23B, or both. One reason for this is that this helps to prevent the positive electrode 21 and the separator 23 from becoming misaligned with each other. In an embodiment, the insulating layer 101 may include a resin including polyvinylidene difluoride (PVDF). One reason for this is that when the insulating layer 101 includes PVDF, the insulating layer 101 is swollen by, for example, a solvent included in the electrolytic solution, which helps to allow the insulating layer 101 to be favorably adhered to the separator 23.

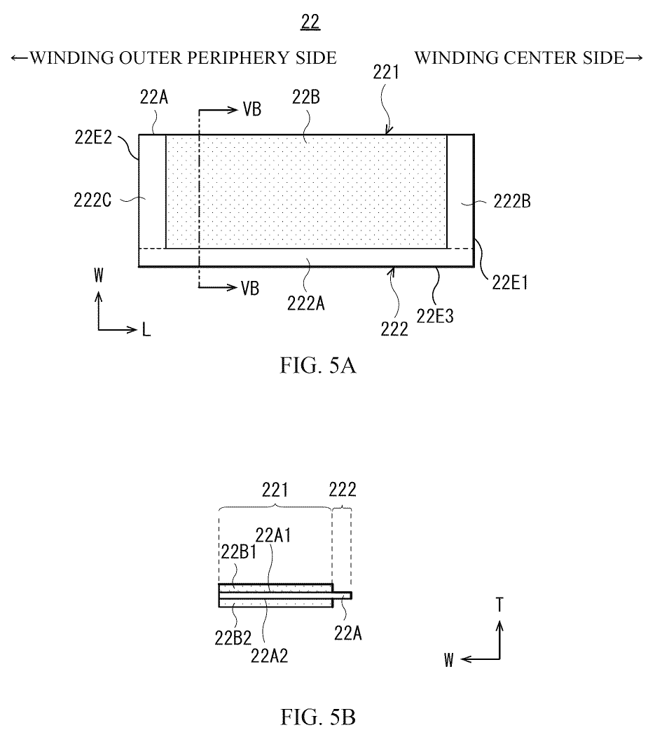

FIG. 5A is a developed view of the negative electrode 22, and schematically illustrates a state before being wound. FIG. 5B illustrates a sectional configuration of the negative electrode 22. Note that FIG. 5B illustrates a section as viewed in an arrowed direction along a line VB-VB illustrated in FIG. 5A. In an embodiment, the negative electrode 22 may include, for example, a negative electrode current collector 22A and a negative electrode active material layer 22B. The negative electrode active material layer 22B may cover a portion of the negative electrode current collector 22A. In an embodiment, the negative electrode active material layer 22B may be provided simply on one of two opposite surfaces of the negative electrode current collector 22A. In an embodiment, the negative electrode active material layer 22B may be provided on each of the two opposite surfaces of the negative electrode current collector 22A. FIG. 5B illustrates an example case where the negative electrode active material layer 22B is provided on each of the two opposite surfaces of the negative electrode current collector 22A. For example, the negative electrode current collector 22A may include an inward surface 22A1 facing toward the central axis CL, and an outward surface 22A2 positioned on an opposite side to the inward surface 22A1. The negative electrode 22 may include an inner winding side negative electrode active material layer 22B1 and an outer winding side negative electrode active material layer 22B2, as the negative electrode active material layers 22B. The inner winding side negative electrode active material layer 22B1 may cover all or a part of the inward surface 22A1 of the negative electrode current collector 22A. The outer winding side negative electrode active material layer 22B2 may cover all or a part of the outward surface 22A2 of the negative electrode current collector 22A. Herein, the inner winding side negative electrode active material layer 22B1 and the outer winding side negative electrode active material layer 22B2 may each be generically referred to as the negative electrode active material layer 22B, without being distinguished from each other.

In an embodiment, the negative electrode 22 may include a negative electrode covered region 221 and a negative electrode exposed region 222. The negative electrode covered region 221 may be a region in which the negative electrode current collector 22A is covered with the negative electrode active material layer 22B. The negative electrode exposed region 222 may be a region in which the negative electrode current collector 22A is not covered with the negative electrode active material layer 22B and is exposed. As illustrated in FIG. 5A, the negative electrode covered region 221 and the negative electrode exposed region 222 may each extend along the L direction, i.e., a longitudinal direction of the negative electrode 22. The negative electrode exposed region 222 may extend from a winding center side edge 22E1 of the negative electrode 22, i.e., an edge of the negative electrode 22 on the winding center side, to a winding outer periphery side edge 22E2 of the negative electrode 22, i.e., an edge of the negative electrode 22 on the winding outer periphery side, in the winding direction of the electrode wound body 20. In contrast, the negative electrode covered region 221 may be provided at neither the winding center side edge 22E1 nor the winding outer periphery side edge 22E2. As illustrated in FIG. 5A, portions of the negative electrode exposed region 222 may be so provided as to allow the negative electrode covered region 221 to be interposed therebetween in the L direction. For example, the negative electrode exposed region 222 may include a first part 222A, a second part 222B, and a third part 222C. The negative electrode 22 may further have a lower edge 22E3 that extends in the L direction on a lower side of the electrode wound body 20. The first part 222A may be adjacent to the negative electrode covered region 221 in the W direction, and may extend from the winding center side edge 22E1 of the negative electrode 22 to the winding outer periphery side edge 22E2 of the negative electrode 22 in the L direction. In other words, the first part 222A may be a region extending from the negative electrode active material layer 22B in the W direction. The second part 222B and the third part 222C may be so provided as to allow the negative electrode covered region 221 to be interposed therebetween in the L direction. The first part 222A may be positioned in a region including the lower edge 22E3 and the vicinity thereof in the negative electrode 22. For example, the second part 222B may be positioned in a region including the winding center side edge 22E1 and the vicinity thereof in the negative electrode 22, and the third part 222C may be positioned in a region including the winding outer periphery side edge 22E2 and the vicinity thereof in the negative electrode 22. Note that FIGS. 5A and 5B each schematically illustrate the negative electrode current collector 22A in the straightened state along the W direction. In actuality, however, as illustrated in FIG. 1, a negative electrode edge part 222E of the negative electrode exposed region 222 may be bent toward the central axis CL and may be coupled to the negative electrode current collector plate 25. In an embodiment, an end part of the negative electrode exposed region 222 in the W direction may form the lower end face 42 and may be coupled to the negative electrode current collector plate 25, as illustrated in FIG. 1. In an embodiment, the lower end face 42 may include the negative electrode edge part 222E, of the negative electrode exposed region 222, that is bent toward the through hole 26 in a state where the stacked body S20 is wound.

In the stacked body S20 of the electrode wound body 20, the positive electrode 21 and the negative electrode 22 may be so stacked on each other with the separator 23 interposed therebetween that the positive electrode exposed region 212 and the first part 222A of the negative electrode exposed region 222 face toward mutually opposite directions along the W direction. In the electrode wound body 20, an end part of the separator 23 may be fixed by attaching a fixing tape 46 to a side surface part 45 of the electrode wound body 20 to thereby prevent loosening of winding.

In an embodiment, as illustrated in FIG. 2, the secondary battery 1 may satisfy A>B, where A is a width of the positive electrode exposed region 212, and B is a width of the first part 222A of the negative electrode exposed region 222. For example, when the width A is 7 (mm), the width B may be 4 (mm). In an embodiment, the secondary battery 1 may satisfy C>D, where C is a width of a portion of the positive electrode exposed region 212 protruding from an outer edge in the width direction of the separator 23, and D is a width of a portion of the first part 222A of the negative electrode exposed region 222 protruding from an opposite outer edge in the width direction of the separator 23. For example, when the width C is 4.5 (mm), the width D may be 3 (mm).

As illustrated in FIG. 1, in the upper part of the secondary battery 1, multiple portions of the positive electrode edge part 212E, of the positive electrode exposed region 212 wound around the central axis CL, that are adjacent to each other in a radial direction, i.e., an R direction, of the electrode wound body 20 may be so bent toward the central axis CL as to overlap each other. The portions of the positive electrode edge part 212E may thus form the upper end face 41 of the electrode wound body 20. Similarly, in the lower part of the secondary battery 1, multiple portions of the negative electrode edge part 222E, of the negative electrode exposed region 222 wound around the central axis CL, that are adjacent to each other in the radial direction, i.e., the R direction, may be so bent toward the central axis CL as to overlap each other. The portions of the negative electrode edge part 222E may thus form the lower end face 42 of the electrode wound body 20. Accordingly, the portions of the positive electrode edge part 212E of the positive electrode exposed region 212 may gather at the upper end face 41 of the electrode wound body 20, and the portions of the negative electrode edge part 222E of the negative electrode exposed region 222 may gather at the lower end face 42 of the electrode wound body 20. To achieve better contact between the positive electrode current collector plate 24 for extracting a current and the positive electrode edge part 212E, the portions of the positive electrode edge part 212E bent toward the central axis CL may form a flat surface. Similarly, to achieve better contact between the negative electrode current collector plate 25 for extracting a current and the negative electrode edge part 222E, the portions of the negative electrode edge part 222E bent toward the central axis CL may form a flat surface. Note that as used herein, the term “flat surface” may encompass not only a completely flat surface but also a surface having some asperities or surface roughness to the extent that joining of the positive electrode exposed region 212 to the positive electrode current collector plate 24 and joining of the negative electrode exposed region 222 to the negative electrode current collector plate 25 are possible.

The positive electrode current collector 21A may include an electrically conductive foil such as an aluminum foil, as will be described later. The negative electrode current collector 22A may include an electrically conductive foil such as a copper foil, as will be described later. In this case, the positive electrode current collector 21A may be softer than the negative electrode current collector 22A. For example, the positive electrode exposed region 212 may have a Young's modulus lower than a Young's modulus of the negative electrode exposed region 222. Accordingly, in an embodiment, the secondary battery 1 may satisfy both A>B and C>D regarding the widths A to D. In such a case, when the positive electrode exposed region 212 and the negative electrode exposed region 222 are substantially simultaneously bent with substantially equal pressures from both electrode sides, the bent portion in the positive electrode 21 and the bent portion in the negative electrode 22 may sometimes become substantially equal in height measured from respective ends of the separator 23. In this case, the portions of the positive electrode edge part 212E of the positive electrode exposed region 212 illustrated in FIG. 1 may appropriately overlap each other by being bent. This helps to allow for easy joining of the positive electrode exposed region 212 and the positive electrode current collector plate 24 to each other. Similarly, the portions of the negative electrode edge part 222E of the negative electrode exposed region 222 illustrated in FIG. 1 may appropriately overlap each other by being bent. This helps to allow for easy joining of the negative electrode exposed region 222 and the negative electrode current collector plate 25 to each other. As used herein, the term “joining” may refer to coupling by, for example, laser welding; however, a method of joining is not limited to laser welding. In an embodiment, any other coupling method may be used.

As illustrated in FIG. 2, a portion, of the positive electrode exposed region 212 of the positive electrode 21, that is opposed to the negative electrode 22 with the separator 23 interposed therebetween may be covered with the insulating layer 101. The insulating layer 101 may have a width of 3 mm in the W direction, for example. The insulating layer 101 may entirely cover a portion, of the positive electrode exposed region 212 of the positive electrode 21, that is opposed to the negative electrode covered region 221 of the negative electrode 22 with the separator 23 interposed therebetween. The insulating layer 101 helps to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 101 absorbs the impact, thereby helping to effectively prevent, for example, bending of the positive electrode exposed region 212 or a short circuit between the positive electrode exposed region 212 and the negative electrode 22.

In an embodiment, the secondary battery 1 may further include insulating tapes 53 and 54 in a gap between the outer package can 11 and the electrode wound body 20. The positive electrode exposed region 212 having portions gathering at the upper end face 41 and the negative electrode exposed region 222 having portions gathering at the lower end face 42 may be electrical conductors, such as metal foils, that are exposed. Accordingly, if the positive electrode exposed region 212 and the negative electrode exposed region 222 are in close proximity to the outer package can 11, a short circuit between the positive electrode 21 and the negative electrode 22 can occur via the outer package can 11. A short circuit can also occur when the positive electrode current collector plate 24 on the upper end face 41 and the outer package can 11 come into close proximity to each other. To address this, in an embodiment, the insulating tapes 53 and 54 may be provided as insulating members. Each of the insulating tapes 53 and 54 may be an adhesive tape including a base layer and an adhesive layer provided on one surface of the base layer. The base layer may include, for example, any one of polypropylene, polyethylene terephthalate, or polyimide. To prevent the provision of the insulating tapes 53 and 54 from resulting in a decreased capacity of the electrode wound body 20, the insulating tapes 53 and 54 may be disposed not to overlap the fixing tape 46 attached to the side surface part 45, and may each have a thickness set to be less than or equal to a thickness of the fixing tape 46.

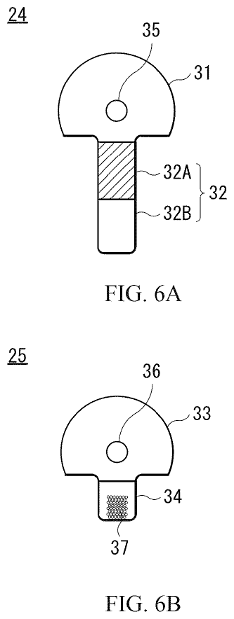

In an existing lithium-ion secondary battery, for example, a lead for current extraction is welded to one location on each of a positive electrode and a negative electrode. However, such a structure increases the internal resistance of the lithium-ion secondary battery, causing the lithium-ion secondary battery to generate heat and become hot upon discharging; therefore, the structure is unsuitable for discharging at a high rate. To address this, in the secondary battery 1 according to an embodiment, the positive electrode current collector plate 24 may be disposed to face the upper end face 41, and the negative electrode current collector plate 25 may be disposed to face the lower end face 42. In addition, the positive electrode exposed region 212 that forms the upper end face 41 and the positive electrode current collector plate 24 may be welded to each other at multiple points; and the negative electrode exposed region 222 that forms the lower end face 42 and the negative electrode current collector plate 25 may be welded to each other at multiple points. This helps to allow for a reduced internal resistance of the secondary battery 1. Each of the upper end face 41 and the lower end face 42 being a flat surface as described above also contributes to the reduced resistance. In an embodiment, the positive electrode current collector plate 24 may be positioned between the battery cover 14 and the upper end face 41. The positive electrode current collector plate 24 may be electrically coupled to the battery cover 14 via the safety valve mechanism 30, for example. In an embodiment, the negative electrode current collector plate 25 may be positioned between the bottom part 11B of the outer package can 11 and the lower end face 42. The negative electrode current collector plate 25 may be electrically coupled to an inner surface of the bottom part 11B of the outer package can 11, for example. FIG. 6A is a developed diagram illustrating a configuration example of the positive electrode current collector plate 24. FIG. 6B is a developed diagram illustrating a configuration example of the negative electrode current collector plate 25. The positive electrode current collector plate 24 may be a metal plate including, for example but not limited to, aluminum or an aluminum alloy as a single component, or a composite material of aluminum and the aluminum alloy. The negative electrode current collector plate 25 may be a metal plate including, for example but not limited to, nickel, a nickel alloy, copper, or a copper alloy as a single component, or a composite material of two or more thereof.

As illustrated in FIG. 6A, the positive electrode current collector plate 24 may include a fan-shaped part 31 and a band-shaped part 32. The fan-shaped part 31 may have a substantially fan shape. The band-shaped part 32 may have a substantially rectangular shape. A shape of the positive electrode current collector plate 24 is, however, not limited to the shape illustrated in FIG. 6A, and may be chosen as desired. Note that in the secondary battery 1, the positive electrode current collector plate 24 may be contained inside the outer package can 11, as illustrated in FIG. 1, in a state where the band-shaped part 32 is bent with respect to the fan-shaped part 31. FIG. 6A illustrates the positive electrode current collector plate 24 in an unbent state. The fan-shaped part 31 may be a facing part facing and coupled to the upper end face 41. The fan-shaped part 31 may have an outer edge including a linear part and a curved part, for example. The fan-shaped part 31 may have an opening 35 in the vicinity of a middle thereof. FIG. 6A illustrates an example case where the opening 35 has a circular plan shape in a horizontal plane orthogonal to the Z-axis direction. The band-shaped part 32 may be coupled to the linear part of the outer edge of the fan-shaped part 31, for example. The band-shaped part 32 may extend in a direction intersecting with the linear part of the fan-shaped part 31. As illustrated in FIG. 1, in the secondary battery 1, the positive electrode current collector plate 24 may be so provided as to allow the opening 35 to overlap the through hole 26 in the Z-axis direction. For example, the opening 35 may be positioned to overlap, in the Z-axis direction, a portion of the upper end face 41 on the winding center side.

A hatched portion in FIG. 6A represents an insulating part 32A of the band-shaped part 32. The insulating part 32A may be a portion of the band-shaped part 32 and may have an insulating tape attached thereto or an insulating material applied thereto. Of the band-shaped part 32, a portion below the insulating part 32A may be a coupling part 32B to be coupled to a sealing plate that also serves as an external terminal. The sealing plate may be electrically continuous with the battery cover 14. Note that when the secondary battery 1 has a battery structure without a metallic center pin in the through hole 26 as illustrated in FIG. 1, there is a low possibility that the band-shaped part 32 will come into contact with a region of a negative electrode potential. In such a case, the positive electrode current collector plate 24 does not have to include the insulating part 32A. When the positive electrode current collector plate 24 does not include the insulating part 32A, a charge and discharge capacity is allowed to be increased by increasing a width of each of the positive electrode 21 and the negative electrode 22 by an amount corresponding to a thickness of the insulating part 32A.

The negative electrode current collector plate 25 illustrated in FIG. 6B may have a shape similar to the shape of the positive electrode current collector plate 24 illustrated in FIG. 6A. The negative electrode current collector plate 25 may include a fan-shaped part 33 and a band-shaped part 34. The fan-shaped part 33 may have a substantially fan shape. The band-shaped part 34 may have a substantially rectangular shape. The shape of the negative electrode current collector plate 25 is, however, not limited to the shape illustrated in FIG. 6B, and may be chosen as desired. Note that in the secondary battery 1, the negative electrode current collector plate 25 may be contained inside the outer package can 11, as illustrated in FIG. 1, in a state where the band-shaped part 34 is bent with respect to the fan-shaped part 33. FIG. 6B illustrates the negative electrode current collector plate 25 in an unbent state. The fan-shaped part 33 may be a facing part facing and coupled to the lower end face 42. The fan-shaped part 33 may have an outer edge including a linear part and a curved part, for example. The band-shaped part 34 may be coupled to the linear part of the outer edge of the fan-shaped part 33, for example. The band-shaped part 34 may extend in a direction intersecting with the linear part of the fan-shaped part 33. The band-shaped part 34 of the negative electrode current collector plate 25 may be shorter than the band-shaped part 32 of the positive electrode current collector plate 24, and may include no portion corresponding to the insulating part 32A of the positive electrode current collector plate 24. The band-shaped part 34 may be provided with projections 37 that are depicted as circles. The projections 37 may each be of a round shape. All or a part of the projections 37 may be welded to the bottom part 11B of the outer package can 11. Upon resistance welding, a current may be concentrated on the projections 37, causing the projections 37 to melt to cause the band-shaped part 34 to be welded to the bottom part 11B of the outer package can 11. As with the positive electrode current collector plate 24, the negative electrode current collector plate 25 may have an opening 36 in the vicinity of a middle of the fan-shaped part 33. In the secondary battery 1, the negative electrode current collector plate 25 may be so provided as to allow the opening 36 to overlap the through hole 26 in the Z-axis direction. FIG. 6B illustrates an example case where the opening 36 has a circular plan shape in a horizontal plane orthogonal to the Z-axis direction.

The fan-shaped part 31 of the positive electrode current collector plate 24 may simply cover a portion of the upper end face 41, owing to a plan shape of the fan-shaped part 31. Similarly, the fan-shaped part 33 of the negative electrode current collector plate 25 may simply cover a portion of the lower end face 42, owing to a plan shape of the fan-shaped part 33. Reasons why the fan-shaped part 31 and the fan-shaped part 33 do not respectively cover the entire upper end face 41 and the entire lower end face 42 include the following example reasons. One reason is to allow the electrolytic solution to smoothly permeate the electrode wound body 20 in assembling the secondary battery 1, for example. In the secondary battery 1 according to an embodiment, the positive electrode current collector plate 24 may be so provided as to allow the opening 35 to overlap a portion of the upper end face 41 on the winding center side in the Z-axis direction. Accordingly, some of the portions of the positive electrode edge part 212E forming the upper end face 41 may not be covered with the fan-shaped part 31 of the positive electrode current collector plate 24 and may be exposed from the opening 35. The secondary battery 1 may thus have a structure that allows for swifter permeation of the electrolytic solution into the electrode wound body 20. Another reason is to allow a gas generated when the lithium-ion secondary battery comes into an abnormally hot state or an overcharged state to be easily released to the outside.

The positive electrode current collector 21A may include an electrically conductive material such as aluminum, for example. The positive electrode current collector 21A may be a metal foil including a material such as aluminum or an aluminum alloy.

The positive electrode active material layer 21B may include, as a positive electrode active material, any one or more of positive electrode materials into which lithium is insertable and from which lithium is extractable. Note that in an embodiment, the positive electrode active material layer 21B may further include any one or more of other materials including, without limitation, a positive electrode binder and a positive electrode conductor. In an embodiment, the positive electrode material may be a lithium-containing compound. In an embodiment, the lithium-containing compound may be a lithium-containing composite oxide or a lithium-containing phosphoric acid compound, for example. The lithium-containing composite oxide may be an oxide including lithium and one or more of other elements, that is, one or more of elements other than lithium, as constituent elements. The lithium-containing composite oxide may have any of crystal structures including, without limitation, a layered rock-salt crystal structure and a spinel crystal structure, for example. The lithium-containing phosphoric acid compound may be a phosphoric acid compound including lithium and one or more of other elements as constituent elements. The lithium-containing phosphoric acid compound may have a crystal structure such as an olivine crystal structure, for example. In an embodiment, the positive electrode active material layer 21B may include, as the positive electrode active material, at least one of lithium cobalt oxide, lithium nickel cobalt manganese oxide, or lithium nickel cobalt aluminum oxide. The positive electrode binder may include, for example, any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride and polyimide. The positive electrode conductor may include, for example, any one or more of materials including, without limitation, a carbon material. Non-limiting examples of the carbon material may include graphite, carbon black, acetylene black, and Ketjen black. Note that in an embodiment, the positive electrode conductor may be any of electrically conductive materials, and may be, for example, a metal material or an electrically conductive polymer.

The negative electrode current collector 22A may include an electrically conductive material such as copper. The negative electrode current collector 22A may be a metal foil including a material such as nickel, a nickel alloy, copper, or a copper alloy. In an embodiment, a surface of the negative electrode current collector 22A may be roughened. One reason for this is that this helps to improve adherence of the negative electrode active material layer 22B to the negative electrode current collector 22A, owing to what is called an anchor effect. In this case, in an embodiment, the surface of the negative electrode current collector 22A may be roughened at least in a region facing the negative electrode active material layer 22B. Non-limiting examples of a roughening method may include a method in which microparticles are formed through an electrolytic treatment. In the electrolytic treatment, the microparticles may be formed on the surface of the negative electrode current collector 22A by an electrolytic method in an electrolyzer. This may provide the surface of the negative electrode current collector 22A with asperities. A copper foil fabricated by the electrolytic method may be generally called an electrolytic copper foil.

The negative electrode active material layer 22B may include, as a negative electrode active material, any one or more of negative electrode materials into which lithium is insertable and from which lithium is extractable. Note that in an embodiment, the negative electrode active material layer 22B may further include any one or more of other materials including, without limitation, a negative electrode binder and a negative electrode conductor. The negative electrode material may be an electrically conductive material such as a carbon material. One reason for this is that the carbon material exhibits very little change in crystal structure at the time of insertion and extraction of lithium, which helps to stably obtain a high energy density. Another reason is that the carbon material also serves as the negative electrode conductor, which helps to improve an electrically conductive property of the negative electrode active material layer 22B. The carbon material may be, for example but not limited to, graphitizable carbon, non-graphitizable carbon, or graphite. In an embodiment, spacing of a (002) plane of the non-graphitizable carbon may be 0.37 nm or greater. In an embodiment, spacing of a (002) plane of the graphite may be 0.34 nm or less. Non-limiting examples of the carbon material may include pyrolytic carbons, cokes, glassy carbon fibers, an organic polymer compound fired body, activated carbon, and carbon blacks. Non-limiting examples of the cokes may include pitch coke, needle coke, and petroleum coke. The organic polymer compound fired body may be a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon, for example. Note that the carbon material may have any of a fibrous shape, a spherical shape, a granular shape, or a flaky shape. In the secondary battery 1, when an open-circuit voltage in a fully charged state, that is, a battery voltage, is 4.25 V or higher, the amount of extracted lithium per unit mass may increase as compared with when the open-circuit voltage in the fully charged state is 4.20 V, even with the same positive electrode active material. The amount of the positive electrode active material and the amount of the negative electrode active material may be therefore adjusted accordingly. This helps to obtain a high energy density.

In an embodiment, the negative electrode active material layer 22B may include, as the negative electrode active material, a silicon-containing material including at least one of silicon, a silicon oxide, a carbon-silicon compound, or a silicon alloy. The term “silicon-containing material” may be a generic term for a material that includes silicon as a constituent element. Note that the silicon-containing material may include only silicon as the constituent element. Only one kind of silicon-containing material may be used, or two or more kinds of silicon-containing materials may be used. The silicon-containing material may be able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline part and an amorphous part. Note that the simple substance described here refers to a simple substance merely in a general sense. The simple substance may thus include a small amount of impurity. In other words, purity of the simple substance is not limited to 100%. The silicon alloy may include, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound may include, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Non-limiting examples of the silicon alloy and the silicon compound may include SiB₄, SiB₆, Mg₂Si, Ni₂Si, TiSi₂, MoSi₂, CoSi₂, NiSi₂, CaSi₂, CrSi₂, CusSi, FeSi₂, MnSi₂, NbSi₂, TaSi₂, VSi₂, WSi₂, ZnSi₂, SiC, Si₃N₄, Si₂N₂O, and SiOᵥ (where 0<v≤2). Note that the range of v may be chosen as desired, and may be, for example, 0.2<v<1.4.

The separator 23 may be interposed between the positive electrode 21 and the negative electrode 22. The separator 23 may allow lithium ions to pass through and prevent a short circuit of a current caused by contact between the positive electrode 21 and the negative electrode 22. The separator 23 may include, for example, any one or more kinds of porous films each including, for example but not limited to, a synthetic resin or a ceramic. In an embodiment, the separator 23 may be a stacked film including two or more kinds of porous films. Non-limiting examples of the synthetic resin may include polytetrafluoroethylene, polypropylene, and polyethylene. In an embodiment, the separator 23 may include a base that includes a single-layer polyolefin porous film including polyethylene. One reason for this is that this helps to obtain a favorable high output characteristic, as compared with a stacked film. In an embodiment, when each of the first separator member 23A and the second separator member 23B included in the separator 23 is a single-layer porous film including polyolefin, the single-layer porous film including polyolefin may have a thickness of greater than or equal to 10 μm and less than or equal to 15 μm, for example. Allowing the single-layer porous film including polyolefin to have a thickness of greater than or equal to 10 μm helps to sufficiently avoid an internal short circuit. Allowing the single-layer porous film including polyolefin to have a thickness of less than or equal to 15 μm helps to achieve a more favorable discharge capacity characteristic. In an embodiment, the single-layer porous film including polyolefin may have a surface density of greater than or equal to 6.3 g/m² and less than or equal to 8.3 g/m², for example. Allowing the single-layer porous film including polyolefin to have a surface density of greater than or equal to 6.3 g/m² helps to sufficiently avoid an internal short circuit. Allowing the single-layer porous film including polyolefin to have a surface density of less than or equal to 8.3 g/m² helps to achieve a more favorable discharge capacity characteristic.

In an embodiment, the separator 23 may include a porous film as the base described above, and a polymer compound layer provided on one of or each of two opposite surfaces of the base. One reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the base is impregnated is also suppressed. This helps to prevent an easy increase in resistance even upon repeated charging and discharging, and also to suppress swelling of the secondary battery. The polymer compound layer may include a polymer compound such as polyvinylidene difluoride. One reason for this is that the polymer compound such as polyvinylidene difluoride has superior physical strength and is electrochemically stable. Note that in an embodiment, the polymer compound may be other than polyvinylidene difluoride. To form the polymer compound layer, for example, a solution in which the polymer compound is dissolved in a solvent such as an organic solvent may be applied on the base, following which the base may be dried. In an embodiment, the base may be immersed in the solution and thereafter dried. In an embodiment, the polymer compound layer may include any one or more kinds of insulating particles such as inorganic particles, for example. Non-limiting examples of the kind of the inorganic particles may include aluminum oxide and aluminum nitride.

The electrolytic solution may include a solvent and an electrolyte salt. In an embodiment, the electrolytic solution may further include any one or more of other materials. Non-limiting examples of the other materials may include an additive. The solvent may include any one or more of nonaqueous solvents including, without limitation, an organic solvent. An electrolytic solution including a nonaqueous solvent may be what is called a nonaqueous electrolytic solution. The nonaqueous solvent may include a fluorine compound and a dinitrile compound, for example. The fluorine compound may include, for example, at least one of fluorinated ethylene carbonate, trifluorocarbonate, trifluoroethyl methyl carbonate, a fluorinated carboxylic acid ester, or a fluorine ether. In an embodiment, the nonaqueous solvent may further include one or more of nitrile compounds other than the dinitrile compound. Non-limiting examples of the nitrile compounds other than the dinitrile compound may include a mononitrile compound and a trinitrile compound. In an embodiment, the dinitrile compound may include succinonitrile (SN). Note that the dinitrile compound is not limited to succinonitrile, and may be any other dinitrile compound such as adiponitrile.

The electrolyte salt may include, for example, any one or more of salts including, without limitation, a lithium salt. In an embodiment, the electrolyte salt may include a salt other than the lithium salt. Non-limiting examples of the salt other than the lithium salt may include a salt of a light metal other than lithium. Non-limiting examples of the lithium salt may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In an embodiment, the lithium salt may include any one or more of LiPF₆, LiBF₄, LiClO₄, or LiAsF₆. In an embodiment, the lithium salt may be LiPF₆. A content of the electrolyte salt is not particularly limited. In an embodiment, the content of the electrolyte salt may be within a range from 0.3 mol/kg to 3 mol/kg both inclusive with respect to the solvent. In an embodiment, when the electrolytic solution includes LiPF₆ as the electrolyte salt, a concentration of LiPF₆ in the electrolytic solution may be within a range from 1.25 mol/kg to 1.45 mol/kg both inclusive. One reason for this is that this helps to prevent cycle deterioration caused by consumption or decomposition of the salt at the time of high load rate charging, and thus helps to improve high-load cyclability characteristic. In an embodiment, when the electrolytic solution further includes LiBF₄ in addition to LiPF₆ as the electrolyte salt, a concentration of LiBF₄ in the electrolytic solution may be within a range from 0.001 wt % to 0.1 wt % both inclusive. One reason for this is that this helps to more effectively prevent the cycle deterioration caused by consumption or decomposition of the salt at the time of high load rate charging, and thus helps to further improve high-load cyclability characteristic.

In the secondary battery 1 according to an embodiment, for example, upon charging, lithium ions may be extracted from the positive electrode 21, and the extracted lithium ions may be inserted into the negative electrode 22 via the electrolytic solution. In the secondary battery 1, for example, upon discharging, lithium ions may be extracted from the negative electrode 22, and the extracted lithium ions may be inserted into the positive electrode 21 via the electrolytic solution.

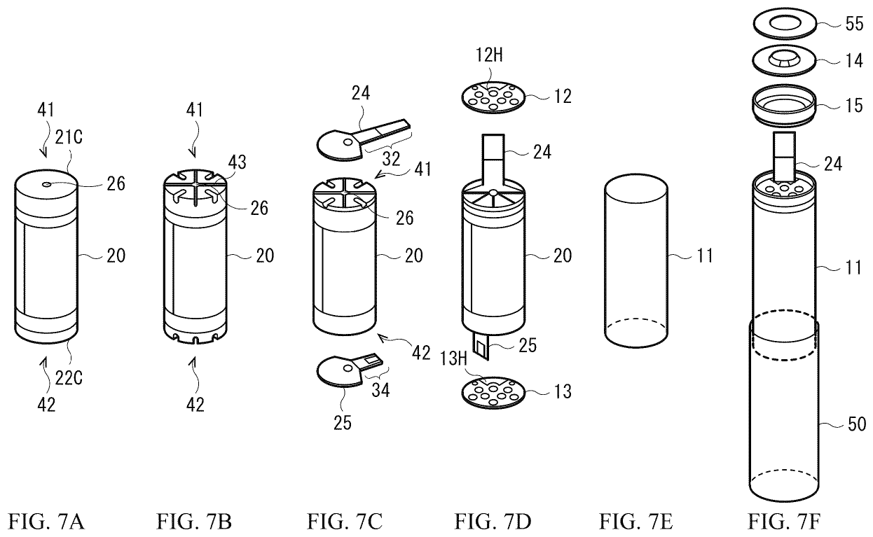

A method of manufacturing the secondary battery 1 will be described with reference to FIGS. 7A to 7F as well as FIGS. 1 to 6B. FIGS. 7A to 7F are each a perspective diagram describing a process of manufacturing the secondary battery 1 illustrated in FIG. 1.

First, the positive electrode current collector 21A may be prepared, and the positive electrode active material layer 21B may be selectively formed on the surface of the positive electrode current collector 21A. Thereafter, the insulating layer 101 may be formed on the surface of the positive electrode current collector 21A, along the first edge 21BT1 of the positive electrode active material layer 21B. Thereafter, a portion of the positive electrode active material layer 21B may be removed by a method such as laser ablation to thereby form the thin part 61. The positive electrode 21 may thus be obtained by the above-described operation. Thereafter, the negative electrode current collector 22A may be prepared, and the negative electrode active material layer 22B may be selectively formed on the surface of the negative electrode current collector 22A to thereby form the negative electrode 22 including the negative electrode covered region 221 and the negative electrode exposed region 222. In an embodiment, the positive electrode 21 and the negative electrode 22 may be subjected to a drying process. Thereafter, the positive electrode 21 and the negative electrode 22 may be stacked, with the first separator member 23A and the second separator member 23B on the positive electrode 21 and the negative electrode 22, respectively, to cause the positive electrode exposed region 212 and the first part 222A of the negative electrode exposed region 222 are on opposite sides to each other in the W direction. The stacked body S20 may thus be fabricated. Thereafter, the stacked body S20 may be so wound in a spiral shape as to form the through hole 26. Upon thus winding the stacked body S20, for example, a circular columnar winding core may be used as a jig, and the stacked body S20 may be wound around the circular columnar winding core. In addition, the fixing tape 46 may be attached to an outermost wind of the stacked body S20 wound in the spiral shape, following which the winding core may be removed. The electrode wound body 20 may thus be obtained as illustrated in FIG. 7A.

Thereafter, as illustrated in FIG. 7B, a portion of the upper end face 41 and a portion of the lower end face 42 of the electrode wound body 20 may each be locally bent by pressing an end of, for example, a 0.5-millimeter-thick flat plate against each of the upper end face 41 and the lower end face 42 perpendicularly, that is, in the Z-axis direction. As a result, grooves 43 may be formed to extend radiately in radial directions (R directions) from the through hole 26. Note that the number and arrangement of the grooves 43 illustrated in FIG. 7B are merely an example, and an embodiment of the present disclosure is not limited thereto. In an embodiment, the number of the grooves 43 may be any other number, and the grooves 43 may be arranged in any other way.

Thereafter, as illustrated in FIG. 7C, substantially equal pressures may be applied to the upper end face 41 and the lower end face 42 in substantially perpendicular directions from above and below the electrode wound body 20 at substantially the same time. At this time, for example, a rod-shaped jig may be placed in the through hole 26 in advance. By this operation, the positive electrode exposed region 212 and the first part 222A of the negative electrode exposed region 222 may be bent to respectively make the upper end face 41 and the lower end face 42 into flat surfaces. In an embodiment, at this time, the portions, of the positive electrode edge part 212E of the positive electrode exposed region 212 at the upper end face 41, that are adjacent to each other in the radial direction of the electrode wound body 20 may be so bent toward the through hole 26 as to overlap each other. Similarly, in an embodiment, the portions, of the negative electrode edge part 222E of the negative electrode exposed region 222 at the lower end face 42, that are adjacent to each other in the radial direction of the electrode wound body 20 may be so bent toward the through hole 26 as to overlap each other. Thereafter, the fan-shaped part 31 of the positive electrode current collector plate 24 may be joined to the upper end face 41 by a method such as laser welding, and the fan-shaped part 33 of the negative electrode current collector plate 25 may be joined to the lower end face 42 by a method such as laser welding.

Thereafter, the insulating tapes 53 and 54 may be attached to predetermined respective locations on the electrode wound body 20. Thereafter, as illustrated in FIG. 7D, the band-shaped part 32 of the positive electrode current collector plate 24 may be bent and passed through a hole 12H of the insulating plate 12. Further, the band-shaped part 34 of the negative electrode current collector plate 25 may be bent and passed through a hole 13H of the insulating plate 13.

Thereafter, the electrode wound body 20 having been assembled in the above-described manner may be placed into the outer package can 11 illustrated in FIG. 7E, following which the bottom part 11B of the outer package can 11 and the negative electrode current collector plate 25 may be welded to each other. Thereafter, a narrow part may be formed in the vicinity of the open end part 11N of the outer package can 11. Further, the electrolytic solution may be injected into the outer package can 11, following which the band-shaped part 32 of the positive electrode current collector plate 24 and the safety valve mechanism 30 may be welded to each other.

Thereafter, as illustrated in FIG. 7F, the outer package can 11 may be sealed with the gasket 15, the safety valve mechanism 30, and the battery cover 14, through the use of the narrow part. Thereafter, the outer package can 11 with the washer 55 attached on the battery cover 14 may be covered with the outer package tube 50, following which the outer package tube 50 may be heated by, for example, applying hot wind to the outer package tube 50. The outer package tube 50 may thus be contracted and closely attached to the outer surface of the outer package can 11.

The secondary battery 1 according to an embodiment may thus be completed.

In the secondary battery 1 according to an embodiment, the thin part 61 and the thick part 71 are provided to be adjacent to each other in the W direction in the positive electrode active material layer 21B, as described above. The W direction is the direction orthogonal to the winding direction, i.e., the L direction. Thus providing the thin part 61 having the small thickness in a portion of the positive electrode active material layer 21B helps to suppress concentration of stress inside the electrode wound body 20 contained in the outer package can 11. For example, it helps to prevent great deformation, such as buckling or bending, of the positive electrode current collector 21A when the negative electrode 22 swells inside the electrode wound body 20 upon charging and discharging. One reason for this is that providing the thin part 61 reduces the amount of the electrode reactant, such as lithium ions, supplied to a partial region of the negative electrode active material layer 22B opposed to the thin part 61, which suppresses expansion and contraction of the partial region of the negative electrode active material layer 22B opposed to the thin part 61. As a result, the stress applied to the separator 23 separating the positive electrode 21 and the negative electrode 22 from each other is also reduced, which helps to avoid breakage of the separator 23 and thereby prevent a short circuit between the positive electrode 21 and the negative electrode 22, even when the separator 23 has a reduced thickness. In other words, it helps to allow for reduction in the thickness of the separator 23. The reduction in the thickness of the separator 23 allows a spacing between the positive electrode 21 and the negative electrode 22 to be reduced, which decreases the internal resistance of the electrode wound body 20. This helps to improve a rate characteristic at the time of charging and discharging and to increase the capacity of the secondary battery 1, for example. In addition, the positive electrode active material layer 21B including the thick part 71 at the position adjacent to the thin part 61 in the W direction helps to allow the separator 23 disposed between the positive electrode active material layer 21B and the negative electrode active material layer 22B to be firmly held. This helps to prevent easy occurrence of winding displacement of the electrode wound body 20 upon expansion and contraction of the electrode wound body 20, and thus helps to prevent the separator 23 from being displaced from a predetermined position. This helps to prevent a short circuit between the positive electrode 21 and the negative electrode 22. Accordingly, the secondary battery 1 according to an embodiment helps to achieve superior reliability.

In an embodiment, the thin part 61 may include the winding center side edge 21E1 of the positive electrode 21 in the L direction. For example, the thin part 61 may be provided at a position closest to the winding center in the positive electrode active material layer 21B. This helps to effectively suppress, in the region inside the electrode wound body 20, concentration of stress at and near the winding center of the electrode wound body 20 where the concentration of stress tends to occur markedly easily.

In an embodiment, the thick part 71 may be provided between the thin part 61 and the insulating layer 101. This helps to allow the insulating layer 101 to have a sufficient thickness, and therefore improve insulating performance of the insulating layer 101. In an embodiment, the thick part 71 may be in contact with the insulating layer 101. This helps to prevent easy detachment of the insulating layer 101 from the positive electrode current collector 21A and the positive electrode active material layer 21B.

In an embodiment, the positive electrode active material layer 21B may further include the thick part 72 that includes the second edge 21BT2 positioned on the opposite side to the first edge 21BT1 in the W direction. This helps to allow the separator 23 disposed between the positive electrode active material layer 21B and the negative electrode active material layer 22B to be held more firmly.

In an embodiment, the positive electrode active material layer 21B may further include the thick part 73 provided on the opposite side of the thin part 61 to the winding center side edge 21E1 in the L direction. This helps to obtain a predetermined battery capacity while suppressing concentration of stress at and near the winding center of the electrode wound body 20.

In an embodiment, each of the inner winding side positive electrode active material layer 21B1 and the outer winding side positive electrode active material layer 21B2 may include the thin part 61 and the thick parts 71 to 73. This helps to further effectively suppress the concentration of stress at and near the winding center of the electrode wound body 20. In an embodiment, the thin part 61 may be provided in a region including the middle of the positive electrode 21 in the W direction, i.e., the width direction of the positive electrode 21. This helps to effectively suppress the concentration of stress inside the electrode wound body 20.

In an embodiment, the secondary battery 1 may include a lithium-ion secondary battery. This helps to allow a sufficient battery capacity to be obtained stably through insertion and extraction of lithium. This helps to achieve higher operation reliability.

Non-limiting examples of applications of the secondary battery 1 according to an embodiment of the present disclosure may be as described below.

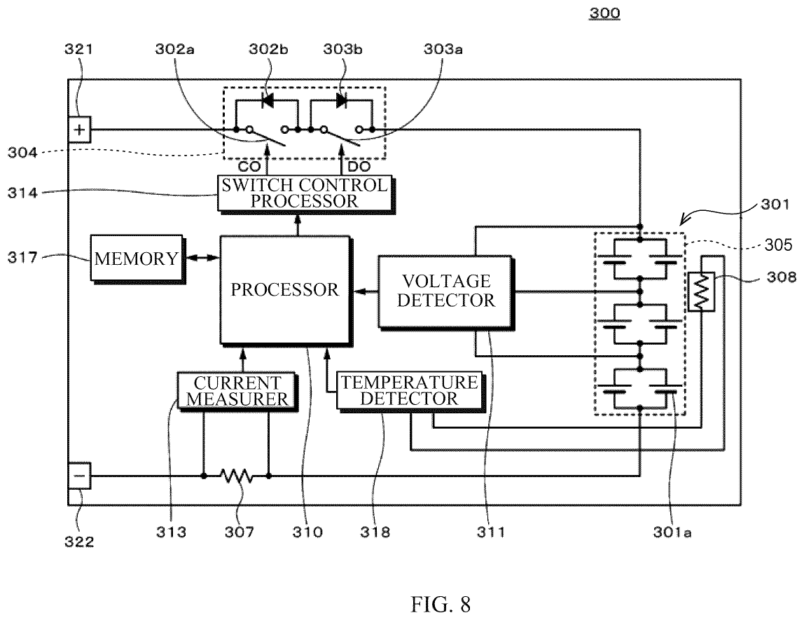

FIG. 8 is a block diagram illustrating a circuit configuration example in which the secondary battery 1 according to an embodiment of the present disclosure is applied to a battery pack 300. The battery pack 300 may include an assembled battery 301, a switcher 304, an outer package body 305, a current detection resistor 307, a temperature detection device 308, and a processor 310. The switcher 304 may include a charge control switch 302a and a discharge control switch 303a. The outer package body 305 may contain the assembled battery 301.

The battery pack 300 may include a positive electrode terminal 321 and a negative electrode terminal 322. Upon charging, the positive electrode terminal 321 and the negative electrode terminal 322 may be respectively coupled to a positive electrode terminal and a negative electrode terminal of a charger to perform charging. Upon use of electronic equipment, the positive electrode terminal 321 and the negative electrode terminal 322 may be respectively coupled to a positive electrode terminal and a negative electrode terminal of the electronic equipment to perform discharging.

The assembled battery 301 may include secondary batteries 301a coupled in series or in parallel. The secondary battery 1 described above is applicable to each of the secondary batteries 301a. FIG. 8 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where each of n and m is an integer.

The switcher 304 may include the charge control switch 302a, a diode 302b, the discharge control switch 303a, and a diode 303b, and may be controlled by the processor 310. The diode 302b may have a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b may have a polarity that is in the forward direction with respect to the charge current and in the reverse direction with respect to the discharge current. In FIG. 8, the switcher 304 may be provided on a positive side; however, in an embodiment, the switcher 304 may be provided on a negative side.

The charge control switch 302a may be so controlled by a charge and discharge control processor that when the battery voltage reaches an overcharge detection voltage, the charge control switch 302a is turned off to thereby prevent the charge current from flowing through a current path of the assembled battery 301. After the charge control switch 302a is turned off, simply discharging may be enabled through the diode 302b. Further, the charge control switch 302a may be so controlled by the processor 310 that when a large current flows upon charging, the charge control switch 302a is turned off to thereby block the charge current flowing through the current path of the assembled battery 301. The discharge control switch 303a may be so controlled by the processor 310 that when the battery voltage reaches an overdischarge detection voltage, the discharge control switch 303a is turned off to thereby prevent the discharge current from flowing through the current path of the assembled battery 301. After the discharge control switch 303a is turned off, simply charging may be enabled through the diode 303b. Further, the discharge control switch 303a may be so controlled by the processor 310 that when a large current flows upon discharging, the discharge control switch 303a is turned off to thereby block the discharge current flowing through the current path of the assembled battery 301.

The temperature detection device 308 may be, for example, a thermistor. The temperature detection device 308 may be provided in the vicinity of the assembled battery 301. The temperature detection device 308 may measure a temperature of the assembled battery 301 and may supply data regarding the measured temperature to the processor 310. A voltage detector 311 may measure a voltage of the assembled battery 301 and a voltage of each of the secondary batteries 301a included therein, may perform A/D conversion on the measured voltages, and may supply data regarding the converted voltages to the processor 310. A current measurer 313 may measure a current by means of the current detection resistor 307 and may supply data regarding the measured current to the processor 310. A switch control processor 314 may control the charge control switch 302a and the discharge control switch 303a of the switcher 304, based on data regarding the voltages supplied from the voltage detector 311 and data regarding the current supplied from the current measurer 313.

When a voltage of any of the secondary batteries 301a reaches the overcharge detection voltage or below, or reaches the overdischarge detection voltage or below, or when a large current flows suddenly, the switch control processor 314 may transmit a control signal to the switcher 304 to thereby prevent overcharging and overdischarging, and overcurrent charging and discharging. For example, when the secondary battery is a lithium-ion secondary battery, the overcharge detection voltage may be determined to be, for example, 4.20 V±0.05 V, and the overdischarge detection voltage may be determined to be, for example, 2.4 V±0.1 V.

As the charge control switch 302a and the discharge control switch 303a, for example, semiconductor switches such as metal-oxide-semiconductor field-effect transistors (MOSFETs) may be used. In this case, parasitic diodes of the MOSFETs may serve as the diodes 302b and 303b. When P-channel FETs are used as the charge control switch 302a and the discharge control switch 303a, the switch control processor 314 may supply control signals DO and CO to a gate of the charge control switch 302a and a gate of the discharge control switch 303a, respectively. When the charge control switch 302a and the discharge control switch 303a are of a P-channel type, the charge control switch 302a and the discharge control switch 303a may each be turned on by a gate potential that is lower than a source potential by a predetermined value or more. For example, in normal charging and discharging operations, the control signals CO and DO may be set to a low level to turn on the charge control switch 302a and the discharge control switch 303a.

For example, upon overcharging or overdischarging, the control signals CO and DO may be set to a high level to turn off the charge control switch 302a and the discharge control switch 303a.

A memory 317 may include a random-access memory (RAM) and a read only memory (ROM). For example, the memory 317 may include a nonvolatile memory such as an erasable programmable read only memory (EPROM). In the memory 317, values including, without limitation, numerical values calculated by the processor 310 and a battery's internal resistance value of each of the secondary batteries 301a in an initial state measured in the manufacturing process stage, may be stored in advance and may be rewritable on an as-needed basis. Further, storing data regarding a full charge capacity of the secondary battery 301a in the memory 317 allows the processor 310 to calculate, for example, a remaining capacity.

A temperature detector 318 may measure a temperature with use of the temperature detection device 308, may perform charge and discharge control upon abnormal heat generation, and may perform correction in calculating the remaining capacity.

### [2-2. Power Storage System]

The above-described secondary battery 1 according to an embodiment of the present disclosure is mountable on, or usable to supply electric power to, for example, any of equipment including, without limitation, electronic equipment, an electric vehicle, an electric aircraft, and a power storage apparatus.

Non-limiting examples of the electronic equipment may include laptop personal computers, smartphones, tablet terminals, personal digital assistants (PDAs) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, traffic lights, and any other electronic equipment to which any embodiment of the present disclosure is applicable.

Non-limiting examples of the electric vehicle may include railway vehicles, golf carts, electric carts, electric automobiles including hybrid electric automobiles, and any other electric vehicle to which any embodiment of the present disclosure is applicable. The secondary battery 1 may be used as a driving power source or an auxiliary power source for any of these electric vehicles. Non-limiting examples of the power storage apparatuses may include a power storage power source for architectural structures including residential houses, or for power generation facilities, and any other power storage apparatus to which any embodiment of the present disclosure is applicable.

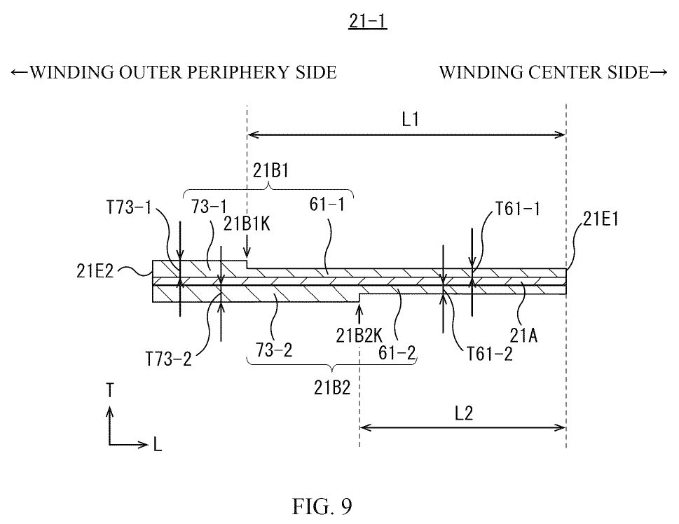

Next, a description is given of a positive electrode 21-1 according to a first modification example. The positive electrode 21-1 may be applied to the secondary battery 1 according to an embodiment described above. FIG. 9 illustrates a sectional configuration of the positive electrode 21-1 and corresponds to FIG. 4C illustrating the positive electrode 21 according to an embodiment described above.

As illustrated in FIG. 9, in the positive electrode 21-1 according to the first modification example, the position of the border 21B1K in the L direction and the position of the border 21B2K in the L direction may be different from each other. In an embodiment, a length L1 from the winding center side edge 21E1 to the position of the border 21B1K and a length L2 from the winding center side edge 21E1 to the position of the border 21B2K may be different from each other. Except for the above-described points, the positive electrode 21-1 may have a configuration substantially the same as the configuration of the positive electrode 21 according to an embodiment described above. The length L1 may correspond to a specific but non-limiting example of a “first length” in an embodiment of the present disclosure. The length L2 may correspond to a specific but non-limiting example of a “second length” in an embodiment of the present disclosure.

As described above, in the positive electrode 21-1, the position of the border 21B1K in the L direction and the position of the border 21B2K in the L direction may be different from each other. For example, a position where a level difference is present in the inner winding side positive electrode active material layer 21B1 and a position where a level difference is present in the outer winding side positive electrode active material layer 21B2 may be different from each other in the L direction. This allows a location where stress is concentrated in the inward surface 21A1 of the positive electrode current collector 21A due to swelling of the negative electrode 22 and a location where stress is concentrated in the outward surface 21A2 of the positive electrode current collector 21A due to the swelling of the negative electrode 22 not to coincide with each other. Accordingly, the stress applied to the positive electrode current collector 21A is dispersed. The secondary battery 1 that includes the electrode wound body 20 including the positive electrode 21-1 according to the first modification example thus helps to still further suppress the concentration of stress inside the electrode wound body 20 occurring due to expansion and contraction, as compared with when the secondary battery 1 includes the positive electrode 21 according to an embodiment described above.

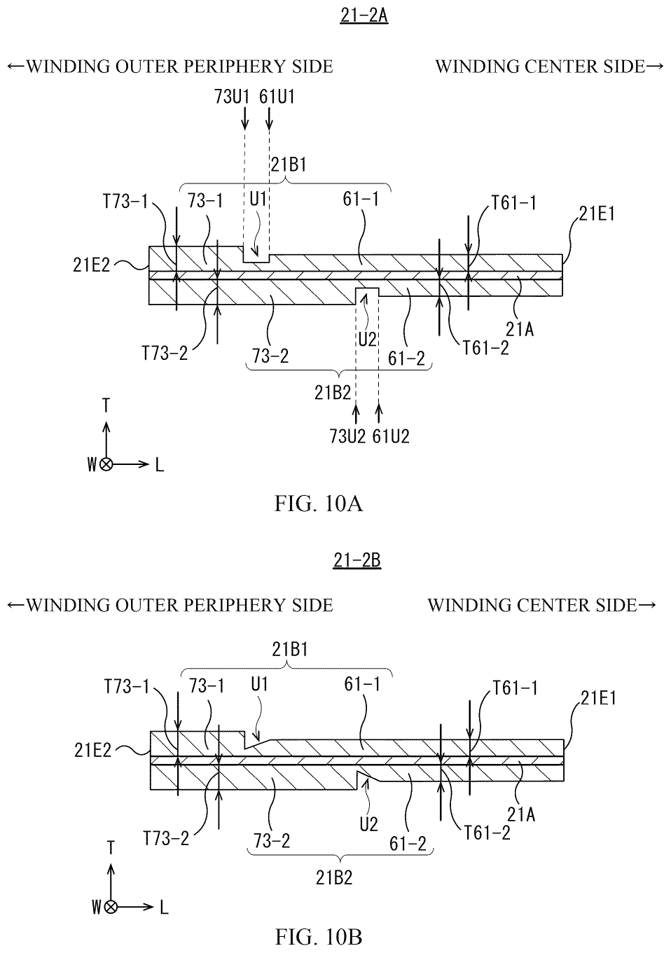

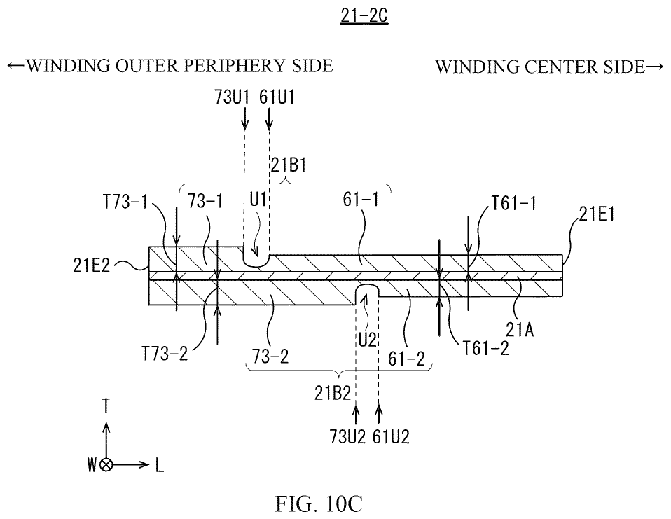

Next, a description is given of a positive electrode 21-2, i.e., each of the positive electrodes 21-2A to 21-2C, according to a second modification example. The positive electrode 21-2, i.e., each of the positive electrode 21-2A to 21-2C, may be applied to the secondary battery 1 according to an embodiment described above. FIGS. 10A to 10C are sectional diagrams respectively illustrating the positive electrodes 21-2A to 21-2C and each correspond to FIG. 4C illustrating the positive electrode 21 according to an embodiment described above.

As illustrated in FIGS. 10A to 10C, in each of the positive electrodes 21-2A to 21-2C according to the second modification example, the inner winding side positive electrode active material layer 21B1 may further include a grooved part U1, and the outer winding side positive electrode active material layer 21B2 may further include a grooved part U2. The grooved part U1 may be positioned between the thick part 73-1 and the thin part 61-1. The grooved part U2 may be positioned between the thick part 73-2 and the thin part 61-2. The grooved parts U1 and U2 may each extend in the W direction. The grooved part U1 may have a thickness still smaller than the thickness T61-1 of the thin part 61-1 in the inner winding side positive electrode active material layer 21B1. Similarly, the grooved part U2 may have a thickness still smaller than the thickness T61-2 of the thin part 61-2 in the outer winding side positive electrode active material layer 21B2. Note that the grooved parts U1 and U2 of the positive electrode 21-2A in FIG. 10A may each have a sectional shape that is substantially rectangular. The grooved parts U1 and U2 of the positive electrode 21-2B in FIG. 10B may each have a sectional shape that is substantially V shaped. The grooved parts U1 and U2 of the positive electrode 21-2C in FIG. 10C may each have a sectional shape that is substantially U shaped. However, the sectional shape of each of the grooved parts U1 and U2 is not limited to that illustrated in each of FIGS. 10A to 10C, and may be chosen as desired.

In each of the positive electrodes 21-2A to 21-2C, a width of the grooved part U1 and a width of the grooved part U2 may be equal to each other in the L direction, or the width of the grooved part U1 and the width of the grooved part U2 may be different from each other in the L direction. The width of the grooved part U1 may refer to a length in the L direction from a position of a border 73U1 between the thick part 73-1 and the grooved part U1 to a position of a border 61U1 between the thin part 61-1 and the grooved part U1. The width of the grooved part U2 may refer to a length in the L direction from a position of a border 73U2 between the thick part 73-2 and the grooved part U2 to a position of a border 61U2 between the thin part 61-2 and the grooved part U2. The width of the grooved part U1 and the width of the grooved part U2 may each be, for example, about 150 μm.

In each of the configuration examples of the positive electrodes 21-2A to 21-2C respectively illustrated in FIGS. 10A to 10C, the position of the border 73U1 in the L direction and the position of the border 73U2 in the L direction may be different from each other, and also the position of the border 61U1 in the L direction and the position of the border 61U2 in the L direction may be different from each other. However, in an embodiment of the present disclosure, the position of the border 73U1 in the L direction and the position of the border 73U2 in the L direction may coincide with each other. In an embodiment, the position of the border 61U1 in the L direction and the position of the border 61U2 in the L direction may coincide with each other. In an embodiment, the position of the border 73U1 in the L direction and the position of the border 73U2 in the L direction may coincide with each other, and in addition, the position of the border 61U1 in the L direction and the position of the border 61U2 in the L direction may coincide with each other.

In each of the configuration examples of the positive electrodes 21-2A to 21-2C respectively illustrated in FIGS. 10A to 10C, the inner winding side positive electrode active material layer 21B1 may include the grooved part U1, and the outer winding side positive electrode active material layer 21B2 may include the grooved part U2. However, in an embodiment, either the grooved part U1 or the grooved part U2 may be simply provided. In an embodiment, each of the positive electrodes 21-2A to 21-2C may simply include either the inner winding side positive electrode active material layer 21B1 or the outer winding side positive electrode active material layer 21B2.

As described above, each of the positive electrodes 21-2A to 21-2C according to the second modification example may have the grooved part U1, the grooved part U2, or both. When the secondary battery 1 includes any of the positive electrodes 21-2A to 21-2C, this helps to allow the separator 23 to be held more firmly between the corresponding one of the positive electrodes 21-2A to 21-2C and the negative electrode 22. One reason for this is that the separator 23 being partly disposed in the grooved part U1, the grooved part U2, or both helps to prevent the separator 23 interposed between the corresponding one of the positive electrodes 21-2A to 21-2C and the negative electrode 22 from being easily displaced or detached from the predetermined position. As a result, the secondary battery 1 including any of the positive electrodes 21-2A to 21-2C helps to effectively prevent a short circuit between the corresponding one of the positive electrodes 21-2A to 21-2C and the negative electrode 22. This helps to achieve further superior reliability.

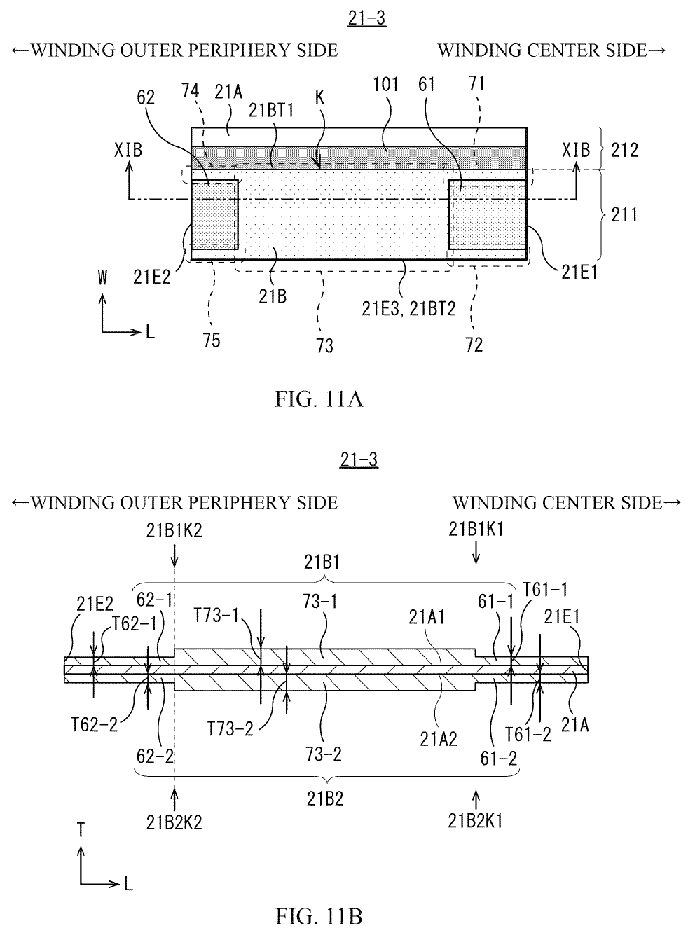

Next, referring to FIGS. 11A and 11B, a description is given of a positive electrode 21-3 according to a third modification example. The positive electrode 21-3 may be applied to the secondary battery 1 according to an embodiment described above. FIG. 11A is a developed view of the positive electrode 21-3 and corresponds to FIG. 4A illustrating the positive electrode 21 according to an embodiment described above. FIG. 11B is a sectional view of the positive electrode 21-3 and corresponds to FIG. 4C illustrating the positive electrode 21 according to an embodiment described above. Note that FIG. 11B illustrates a section as viewed in an arrowed direction along a line XIB-XIB illustrated in FIG. 11A.

As illustrated in FIGS. 11A and 11B, in an embodiment, the positive electrode active material layer 21B of the positive electrode 21-3 may further include a thin part 62. The thin part 62 may be positioned on an opposite side of the thick part 73 to the thin part 61. The thin part 62 may have a thickness smaller than the thickness of the thick part 73. The thin part 62 may include a winding outer periphery side edge 21E2 of the positive electrode 21-3, i.e., an edge of the positive electrode 21-3 on the winding outer periphery side in the L direction. In an embodiment, the thin part 62 may have a length in the L direction that corresponds to, for example, about a half wind or less of the electrode wound body 20 from the winding outer periphery side edge 21E2. The positive electrode active material layer 21B may further include a thick part 74 adjacent to the thin part 62 in the W direction. For example, the thick part 74 may be positioned between the thin part 62 and the insulating layer 101 in the W direction. In an embodiment, the thick part 74 may include the first edge 21BT1 and may be in contact with the insulating layer 101. The positive electrode active material layer 21B may further include a thick part 75. The thick part 75 may include the second edge 21BT2. The thin part 62 may correspond to a specific but non-limiting example of a “second thin part” in an embodiment of the present disclosure.

In the positive electrode 21-3 according to the third modification example, the thin part 62 may be provided on each of the inward surface 21A1 of the positive electrode current collector 21A and the outward surface 21A2 of the positive electrode current collector 21A. In other words, each of the inner winding side positive electrode active material layer 21B1 and the outer winding side positive electrode active material layer 21B2 may include the thin part 62. In an embodiment, however, at least either the inner winding side positive electrode active material layer 21B1 of the positive electrode 21-3 or the outer winding side positive electrode active material layer 21B2 of the positive electrode 21-3 may include the thin part 62. Note that, for convenience, in FIG. 11B, the thin part 62 included in the inner winding side positive electrode active material layer 21B1 is denoted as a thin part 62-1; and the thin part 62 included in the outer winding side positive electrode active material layer 21B2 is denoted as a thin part 62-2. Further, in the modification example illustrated in FIG. 11B, a position of a border 21B1K1 between the thin part 61-1 and the thick part 73-1 in the L direction may substantially coincide with a position of a border 21B2K1 between the thin part 61-2 and the thick part 73-2 in the L direction. In the modification example illustrated in FIG. 11B, a position of a border 21B1K2 between the thin part 62-1 and the thick part 73-1 in the L direction may substantially coincide with a position of a border 21B2K2 between the thin part 62-2 and the thick part 73-2 in the L direction.

In the positive electrode 21-3 according to the third modification example, in addition to the thin part 61, the thin part 62 may be provided on the winding outer periphery side of the electrode wound body 20. This helps to reduce a level difference between a portion where the positive electrode 21 is present and a portion where no positive electrode 21 is present on the winding outer periphery side of the electrode wound body 20, as compared with when the positive electrode 21 with no thin part 62 is provided. This helps to suppress concentration of stress at a location, of the separator 23, that overlaps the winding outer periphery side edge 21E2. Suppressing the concentration of stress helps to avoid breakage of the separator 23 even when the separator 23 has a small thickness and to prevent a short circuit between the positive electrode 21 and the negative electrode 22. In other words, it helps to allow for reduction in the thickness of the separator 23. The reduction in the thickness of the separator 23 allows a spacing between the positive electrode 21 and the negative electrode 22 to be reduced, which decreases the internal resistance of the electrode wound body 20. This helps to improve a rate characteristic at the time of charging and discharging and to increase the capacity of the secondary battery 1, for example.

### EXAMPLES

A description is given of Examples of an embodiment of the present disclosure.

### [Fabrication Method]

### Example 1-1

As described below, the cylindrical secondary battery illustrated in FIG. 1, etc. was fabricated. Here, lithium-ion secondary battery was fabricated with dimensions of 21 mm in diameter and 70 mm in length in nominal values.

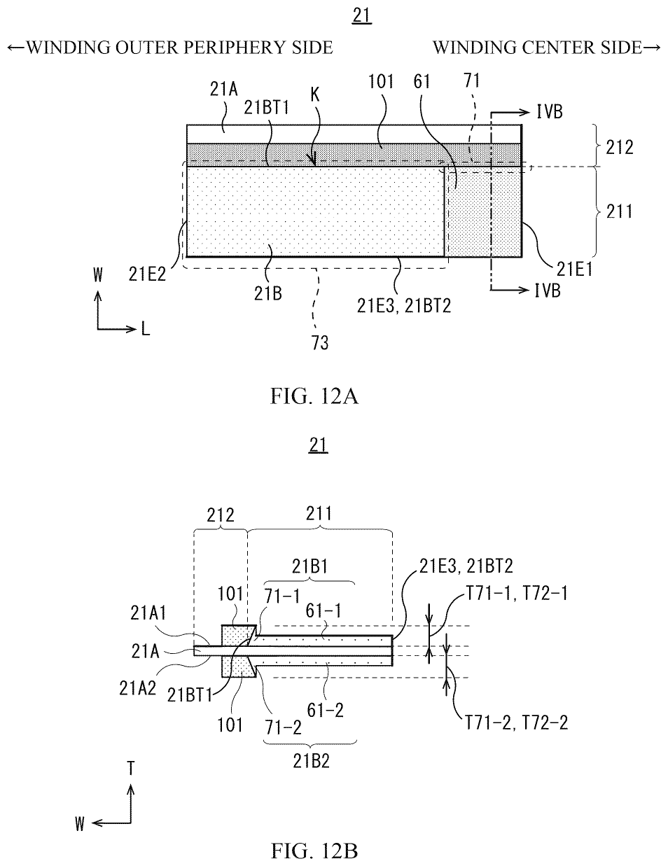

First, an aluminum foil having a thickness of 12 μm was prepared as the positive electrode current collector 21A. Thereafter, a layered lithium oxide as the positive electrode active material was mixed with a positive electrode binder and a conductive additive to thereby obtain a positive electrode mixture. The layered lithium oxide included lithium nickel cobalt aluminum oxide (NCA) having a Ni ratio of 85% or greater. The positive electrode binder included polyvinylidene difluoride. The conductive additive included a mixture of carbon black, acetylene black, and Ketjen black. A mixture ratio between the positive electrode active material, the positive electrode binder, and the conductive additive was set to 96.4:2:1.6. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on respective predetermined regions of the two opposite surfaces of the positive electrode current collector 21A by means of a coating apparatus, following which the applied positive electrode mixture slurry was dried to thereby form the positive electrode active material layers 21B. Further, a coating material including polyvinylidene difluoride (PVDF) was applied on two opposite surfaces in the positive electrode exposed region 212, at respective regions adjacent to the positive electrode covered region 211. The applied coating material was dried to thereby form the insulating layers 101 each having a width of 3 mm and a thickness of 8 μm. Thereafter, the positive electrode active material layers 21B were compression-molded by means of a roll pressing machine. Further, a portion of each of the positive electrode active material layers 21B was removed by laser ablation to thereby form the thin part 61 including the winding center side edge 21E1. At this time, as illustrated in FIGS. 12A and 12B, the thick part 71 (i.e., each of the thick parts 71-1 and 71-2) was formed by partially leaving each of the positive electrode active material layers 21B unremoved simply at a portion that included the inclined surface (i.e., a surface including the first edge 21BT1) covered with the insulating layer 101. Further, the thin part 61 was formed without forming the thick parts 72 (i.e., each of the thick parts 72-1 and 72-2). FIG. 12A is a developed view of the positive electrode 21 of Example 1-1, and FIG. 12B is a sectional view of the positive electrode 21 of Example 1-1. Note that in Example 1-1, the positions, the dimensions, and the shapes of the thin part 61-1 and the thick part 71-1 of the inner winding side positive electrode active material layer 21B1 were substantially the same as the positions, the dimensions, and the shapes of the thin part 61-2 and the thick part 71-2 of the outer winding side positive electrode active material layer 21B2, respectively. Here, the length of the thin part 61 in the L direction, i.e., the length from the winding center side edge 21E1 to each of the borders 21B1K and 21B2K was 30 mm. Thus, the positive electrode 21 including the positive electrode covered region 211 and the positive electrode exposed region 212 was obtained. Thereafter, the positive electrode 21 was subjected to shearing to set a width of the positive electrode covered region 211 in the W direction to 60 mm, and a width of the positive electrode exposed region 212 in the W direction to 7 mm. Further, a length of the positive electrode 21 in the L direction was set to 1700 mm.

Further, a copper foil having a thickness of 8 μm was prepared as the negative electrode current collector 22A. Thereafter, the negative electrode active material was mixed with a negative electrode binder and a conductive additive to thereby obtain a negative electrode mixture. The negative electrode active material included a mixture of a carbon material including graphite and SiO. The negative electrode binder included polyvinylidene difluoride. The conductive additive included a mixture of carbon black, acetylene black, and Ketjen black. A mixture ratio between the negative electrode active material, the negative electrode binder, and the conductive additive was set to 96.1:2.9:1.0. A mixture ratio between graphite and SiO in the negative electrode active material was set to 95:5. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on respective predetermined regions of two opposite surfaces of the negative electrode current collector 22A by means of a coating apparatus, following which the applied negative electrode mixture slurry was dried to thereby form the negative electrode active material layers 22B. Thereafter, the negative electrode active material layers 22B were compression-molded by means of a roll pressing machine. The negative electrode 22 including the negative electrode covered region 221 and the negative electrode exposed region 222 was thus obtained. Thereafter, the negative electrode 22 was subjected to shearing to set a width of the negative electrode covered region 221 in the W direction to 62 mm, and a width of the first part 222A of the negative electrode exposed region 222 in the W direction to 4 mm. Further, a length of the negative electrode 22 in the L direction was set to 1760 mm.

Thereafter, the positive electrode 21 and the negative electrode 22 were so stacked on each other with the first separator member 23A and the second separator member 23B on the positive electrode 21 and the negative electrode 22, respectively, as to allow the positive electrode exposed region 212 and the first part 222A of the negative electrode exposed region 222 to be on mutually opposite sides to each other in the W direction. The stacked body S20 was thus fabricated. At this time, the stacked body S20 was fabricated not to allow the positive electrode active material layers 21B to protrude from the negative electrode active material layers 22B in the W direction. As the first separator member 23A and the second separator member 23B, polyethylene sheets each having a width of 65 mm and a thickness of 5 μm were used. Thereafter, the stacked body S20 was so wound in a spiral shape as to form the through hole 26, and the fixing tape 46 was attached to the outermost wind of the stacked body S20 thus wound.

Thereafter, the upper end face 41 and the lower end face 42 of the electrode wound body 20 were each locally bent by pressing an end of a 0.5-millimeter-thick flat plate against each of the upper end face 41 and the lower end face 42 in the Z-axis direction to thereby form the grooves 43 extending radiately in the radial directions (i.e., the R directions) from the through hole 26.

Thereafter, substantially equal pressures were applied to the upper end face 41 and the lower end face 42 in substantially perpendicular directions from above and below the electrode wound body 20 at substantially the same time. By this operation, the positive electrode exposed region 212 and the first part 222A of the negative electrode exposed region 222 were bent to respectively make the upper end face 41 and the lower end face 42 into flat surfaces. At this time, portions of the positive electrode edge part 212E of the positive electrode exposed region 212 at the upper end face 41 were so bent toward the through hole 26 as to overlap each other; and portions of the negative electrode edge part 222E of the negative electrode exposed region 222 at the lower end face 42 were so bent toward the through hole 26 as to overlap each other. Thereafter, the fan-shaped part 31 of the positive electrode current collector plate 24 was joined to the upper end face 41 by laser welding, and the fan-shaped part 33 of the negative electrode current collector plate 25 was joined to the lower end face 42 by laser welding. The positive electrode current collector plate 24 was used that included the fan-shaped part 31 provided with the opening 35 having an inner diameter D35 of 4.0 mm.

Thereafter, the insulating tapes 53 and 54 were attached to the predetermined respective locations on the electrode wound body 20. Thereafter, the band-shaped part 32 of the positive electrode current collector plate 24 was bent and passed through the hole 12H of the insulating plate 12. Further, the band-shaped part 34 of the negative electrode current collector plate 25 was bent and passed through the hole 13H of the insulating plate 13.

Thereafter, the electrode wound body 20 having been assembled in the above-described manner was placed into the outer package can 11, following which the bottom part 11B of the outer package can 11 and the negative electrode current collector plate 25 were welded to each other. Note that the outer package can 11 had an inner diameter D11 of 20.80 mm+0.05 mm.

Thereafter, the narrow part was formed in the vicinity of the open end part 11N of the outer package can 11. Further, the electrolytic solution was injected into the outer package can 11, following which the band-shaped part 32 of the positive electrode current collector plate 24 and the safety valve mechanism 30 were welded to each other.

As the electrolytic solution, used was a solution including: a solvent in which fluoroethylene carbonate (FEC) and succinonitrile (SN) were added to a major solvent, i.e., ethylene carbonate (EC) and dimethyl carbonate (DMC); and LiBF₄ and LiPF₆ as the electrolyte salt. In the lithium-ion secondary battery of Example 1-1, a content ratio (wt %) between EC, DMC, FEC, SN, LiBF₄, and LiPF₆ in the electrolytic solution was set to 12.7:56.2:12.0:1.0:1.0:17.1.

Thereafter, the outer package can 11 was sealed with the gasket 15, the safety valve mechanism 30, and the battery cover 14, through the use of the narrow part. Thereafter, the outer package can 11 with the washer 55 attached on the battery cover 14 was covered with the outer package tube 50, following which the outer package tube 50 was heated by applying hot air to the outer package tube 50. The outer package tube 50 was thus contracted and closely attached to the outer surface of the outer package can 11.

The secondary battery of Example 1-1 was thus obtained.

### Examples 1-2 to 1-5

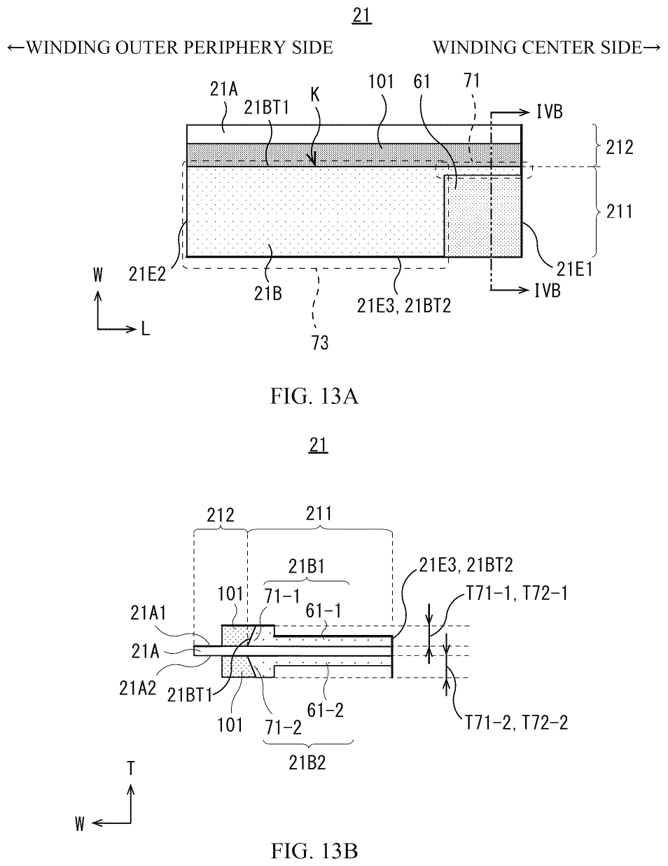

When forming the thin part 61 by laser ablation, as illustrated in FIGS. 13A and 13B, the thick part 71 (i.e., each of the thick parts 71-1 and 71-2) was formed by partially leaving each of the positive electrode active material layers 21B unremoved, not only at a portion including the inclined surface (i.e., the surface including the first edge 21BT1) covered with the insulating layer 101 but also at a portion not covered with the insulating layer 101. FIG. 13A is a developed view of the positive electrode 21 of each of Examples 1-2 to 1-5, and FIG. 13B is a sectional view of the positive electrode 21 of each of Examples 1-2 to 1-5. Except for the above-described point, the secondary batteries of Examples 1-2 to 1-5 were each fabricated in a similar manner to Example 1-1. Note that, in Example 1-2, a width of the thick part 71 in the W direction was set to 6 mm that corresponded to 10% of an entire width of 60 mm of the positive electrode covered region 211 in the W direction. Similarly, in Example 1-3, the width of the thick part 71 in the W direction was set to 12 mm that corresponded to 20% of the entire width of 60 mm of the positive electrode covered region 211 in the W direction. In Example 1-4, the width of the thick part 71 in the W direction was set to 20 mm that corresponded to 33% of the entire width of 60 mm of the positive electrode covered region 211 in the W direction. In Example 1-5, the width of the thick part 71 in the W direction was set to 30 mm that corresponded to 50% of the entire width of 60 mm of the positive electrode covered region 211 in the W direction, respectively.

### Examples 1-6 to 1-9

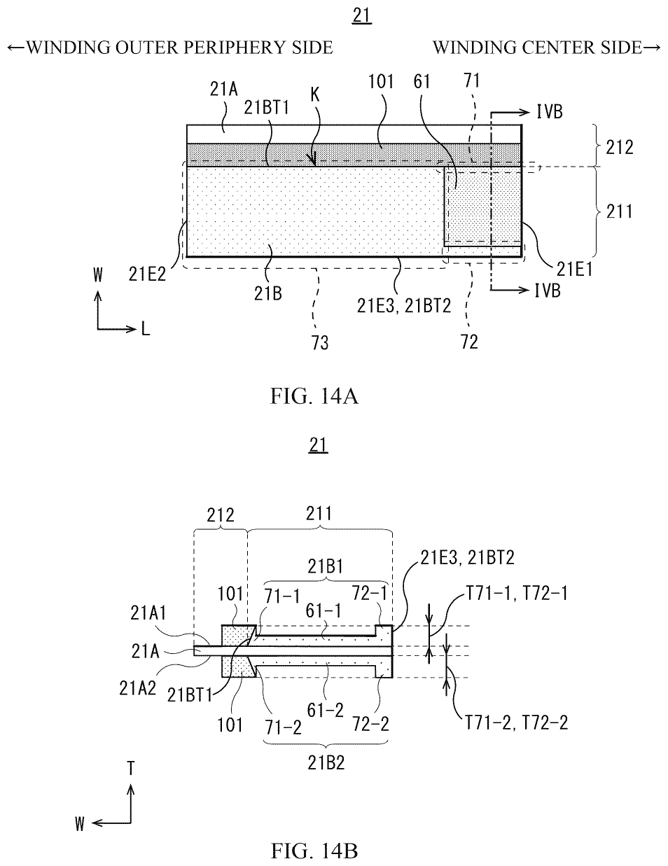

When forming the thin part 61 by laser ablation, as illustrated in FIGS. 14A and 14B, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. FIG. 14A is a developed view of the positive electrode 21 of each of Examples 1-6 to 1-9, and FIG. 14B is a sectional view of the positive electrode 21 of each of Examples 1-6 to 1-9. Except for the above-described point, the secondary batteries of Examples 1-6 to 1-9 were each fabricated in a similar manner to Example 1-1. Note that, in Example 1-6, a width of the thick part 72 in the W direction was set to 6 mm that corresponded to 10% of the entire width of 60 mm of the positive electrode covered region 211 in the W direction. Similarly, in Example 1-7, the width of the thick part 72 in the W direction was set to 12 mm that corresponded to 20% of the entire width of 60 mm of the positive electrode covered region 211 in the W direction. In Example 1-8, the width of the thick part 72 in the W direction was set 20 mm that corresponded to 33% of the entire width of 60 mm of the positive electrode covered region 211 in the W direction. In Example 1-9, the width of the thick part 72 in the W direction was set 30 mm that corresponded to 50% of the entire width of 60 mm of the positive electrode covered region 211 in the W direction.

### Examples 1-10 to 1-15

When forming the thin part 61 by laser ablation, as illustrated in FIGS. 4A and 4B, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary batteries of Examples 1-6 to 1-9 were each fabricated in a similar manner to Example 1-1. Note that, in Example 1-6, the width of each of the thick parts 71 and 72 in the W direction was set to 3 mm that corresponded to 5% of the entire width of 60 mm of the positive electrode covered region 211 in the W direction. Similarly, in Example 1-11, the widths of the thick parts 71 and 72 in the W direction were set to 6 mm that corresponded to 10% of the entire width of 60 mm of the positive electrode covered region 211 in the W direction. In Example 1-12, the widths of the thick parts 71 and 72 in the W direction were set to 9 mm that corresponded to 15% of the entire width of 60 mm of the positive electrode covered region 211 in the W direction. In Example 1-13, the widths of the thick parts 71 and 72 in the W direction were set to 15 mm that corresponded to 25% of the entire width of 60 mm of the positive electrode covered region 211 in the W direction. In Example 1-14, the widths of the thick parts 71 and 72 in the W direction were set to 20 mm that corresponded to 33% of the entire width of 60 mm of the positive electrode covered region 211 in the W direction. In Example 1-15, the widths of the thick parts 71 and 72 in the W direction were set to 24 mm that corresponded to 40% of the entire width of 60 mm of the positive electrode covered region 211 in the W direction.

### Example 2-1

The secondary battery of Example 2-1 was fabricated in a similar manner to Example 1-1 except that the positive electrode 21-1 illustrated in FIG. 9 was used instead of the positive electrode 21. When a portion of the positive electrode active material layer 21B was removed by laser ablation to thereby form the thin part 61 including the winding center side edge 21E1, the position of the border 21B1K in the inner winding side positive electrode active material layer 21B1 in the L direction and the position of the border 21B2K in the inner winding side positive electrode active material layer 21B1 in the L direction were set to be different from each other. Further, when forming the thin part 61, as illustrated in FIGS. 12A and 12B, the thick part 71 (i.e., each of the thick parts 71-1 and 71-2) was formed by leaving a portion of each of the positive electrode active material layers 21B unremoved simply at a portion including the inclined surface (i.e., the surface including the first edge 21BT1) covered with the insulating layer 101, but no thick part 72 (i.e., neither of the thick parts 72-1 and 72-2) was formed.

### Example 2-2

When forming the thin part 61 by laser ablation, as illustrated in FIGS. 13A and 13B, the thick part 71 (i.e., each of the thick parts 71-1 and 71-2) was formed by partially leaving each of the positive electrode active material layers 21B unremoved, not only at a portion including the inclined surface (i.e., the surface including the first edge 21BT1) covered with the insulating layer 101 but also at a portion not covered with the insulating layer 101. Except for the above-described point, the secondary battery of Example 2-2 was fabricated in a similar manner to Example 2-1. Note that, in Example 2-2, the width of the thick part 71 in the W direction was set to 6 mm that corresponded to 10% of the entire width of 60 mm of the positive electrode covered region 211 in the W direction.

### Example 2-3

When forming the thin part 61 by laser ablation, as illustrated in FIGS. 14A and 14B, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary battery of Example 2-3 was fabricated in a similar manner to Example 2-1. Note that, in Example 2-3, the width of the thick part 72 in the W direction was set to 6 mm that corresponded to 10% of the entire width of 60 mm of the positive electrode covered region 211 in the W direction.

### Example 2-4

When forming the thin part 61 by laser ablation, as illustrated in FIGS. 4A and 4B, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary battery of Example 2-4 was fabricated in a similar manner to Example 2-1. Note that, in Example 2-4, the width of each of the thick parts 71 and 72 in the W direction was set to 6 mm that corresponded to 10% of the entire width of 60 mm of the positive electrode covered region 211 in the W direction.

### Example 3-1

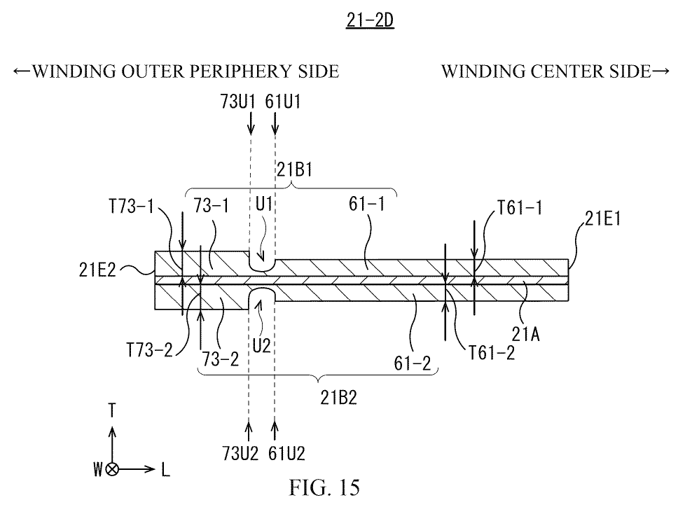

The secondary battery of Example 3-1 was fabricated in a similar manner to Example 1-1 except that a positive electrode 21-2D illustrated in FIG. 15 was used instead of the positive electrode 21. For example, when forming the thin part 61 including the winding center side edge 21E1 by removing a portion of each of the positive electrode active material layers 21B by laser ablation, each of the grooved parts U1 and U2 was formed between the thin part 61 and the thick part 73: the grooved part U1 was formed between the thin part 61-1 and the thick part 73-1, and the grooved part U2 was formed between the thin part 61-2 and the thick part 73-2. At this time, the position of the groove U1 in the L direction and the position of the groove U2 in the L direction coincided with each other.

### Example 3-2

When forming the thin part 61 by laser ablation, the thick part 71 (i.e., each of the thick parts 71-1 and 71-2) was formed by partially leaving each of the positive electrode active material layers 21B unremoved, not only at a portion including the inclined surface (i.e., the surface including the first edge 21BT1) covered with the insulating layer 101 but also at a portion not covered with the insulating layer 101. Except for the above-described point, the secondary battery of Example 3-2 was fabricated in a similar manner to Example 3-1. Note that, in Example 3-2, the width of the thick part 71 in the W direction was set to 6 mm that corresponded to 10% of the entire width of 60 mm of the positive electrode covered region 211 in the W direction.

### Example 3-3

When forming the thin part 61 by laser ablation, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary battery of Example 3-3 was fabricated in a similar manner to Example 3-1. Note that, in Example 3-3, the width of the thick part 72 in the W direction was set to 6 mm that corresponded to 10% of the entire width of 60 mm of the positive electrode covered region 211 in the W direction.

### Example 3-4

When forming the thin part 61 by laser ablation, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary battery of Example 3-4 was fabricated in a similar manner to Example 3-1. Note that, in Example 3-4, the width of each of the thick parts 71 and 72 in the W direction was set to 6 mm that corresponded to 10% of the entire width of 60 mm of the positive electrode covered region 211 in the W direction.

### Example 4-1

The secondary battery of Example 4-1 was fabricated in a similar manner to Example 1-1 except that the positive electrode 21-2C illustrated in FIG. 10C was used instead of the positive electrode 21. When forming the thin part 61 including the winding center side edge 21E1 by removing a portion of the positive electrode active material layer 21B by laser ablation, each of the grooved parts U1 and U2 was formed between the thin part 61 and the thick part 73: the grooved part U1 was formed between the thin part 61-1 and the thick part 73-1, and the grooved part U2 was formed between the thin part 61-2 and the thick part 73-2. At this time, the position of the grooved part U1 in the L direction and the position of the grooved part U2 in the L direction were set to be different from each other.

### Example 4-2

When forming the thin part 61 by laser ablation, the thick part 71 (i.e., each of the thick parts 71-1 and 71-2) was formed by partially leaving each of the positive electrode active material layers 21B unremoved, not only at a portion including the inclined surface (i.e., the surface including the first edge 21BT1) covered with the insulating layer 101 but also at a portion not covered with the insulating layer 101. Except for the above-described point, the secondary battery of Example 4-2 was fabricated in a similar manner to Example 4-1. Note that, in Example 4-2, the width of the thick part 71 in the W direction was set to 6 mm that corresponded to 10% of the entire width of 60 mm of the positive electrode covered region 211 in the W direction.

### Example 4-3

When forming the thin part 61 by laser ablation, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary battery of Example 4-3 was fabricated in a similar manner to Example 4-1. Note that, in Example 4-3, the width of the thick part 72 in the W direction was set to 6 mm that corresponded to 10% of the entire width of 60 mm of the positive electrode covered region 211 in the W direction.

### Example 4-4

When forming the thin part 61 by laser ablation, the thick part 71 (i.e., each of the thick parts 71-1 and 71-2) and the thick part 72 (i.e., each of the thick parts 72-1 and 72-2) were formed by partially leaving each of the positive electrode active material layers 21B unremoved at a portion including the inclined surface (i.e., the surface including the first edge 21BT1) covered with the insulating layer 101 and also at a portion not covered with the insulating layer 101. Except for the above-described point, the secondary battery of Example 4-4 was fabricated in a similar manner to Example 4-1. Note that, in Example 4-4, the width of each of the thick parts 71 and 72 in the W direction was set to 6 mm that corresponded to 10% of the entire width of 60 mm of the positive electrode covered region 211 in the W direction.

### Example 5-1

Of the inner winding side positive electrode active material layer 21B1 and the outer winding side positive electrode active material layer 21B2 each provided on the positive electrode current collector 21A, the thin part 61 was provided simply in the inner winding side positive electrode active material layer 21B1 provided on the inward surface 21A1 of the positive electrode current collector 21A. For example, in Example 5-1, the thin part 61 was not formed in the outer winding side positive electrode active material layer 21B2 provided on the outward surface 21A2 of the positive electrode current collector 21A, and the outer winding side positive electrode active material layer 21B2 had a uniform thickness throughout. Except for the above-described point, the secondary battery of Example 5-1 was fabricated in a similar manner to Example 1-1.

### Example 5-2

Of the inner winding side positive electrode active material layer 21B1 and the outer winding side positive electrode active material layer 21B2 each provided on the positive electrode current collector 21A, the thin part 61 was provided simply in the inner winding side positive electrode active material layer 21B1 provided on the inward surface 21A1 of the positive electrode current collector 21A. In Example 5-2, the thin part 61 was not formed in the outer winding side positive electrode active material layer 21B2 provided on the outward surface 21A2 of the positive electrode current collector 21A, and the outer winding side positive electrode active material layer 21B2 had a uniform thickness throughout. Except for the above-described point, the secondary battery of Example 5-2 was fabricated in a similar manner to Example 1-11.

### Example 5-3

Of the inner winding side positive electrode active material layer 21B1 and the outer winding side positive electrode active material layer 21B2 each provided on the positive electrode current collector 21A, the thin part 61 and the grooved part U1 were provided simply in the inner winding side positive electrode active material layer 21B1 provided on the inward surface 21A1 of the positive electrode current collector 21A. In Example 5-2, neither the thin part 61 nor the grooved part U2 was formed in the outer winding side positive electrode active material layer 21B2 provided on the outward surface 21A2 of the positive electrode current collector 21A, and the outer winding side positive electrode active material layer 21B2 had a uniform thickness throughout. Except for the above-described point, the secondary battery of Example 5-3 was fabricated in a similar manner to Example 3-4.

### Example 6-1

The secondary battery of Example 6-1 was fabricated in a similar manner to Example 1-11 except that the positive electrode 21-3 illustrated in FIGS. 11A and 11B was used instead of the positive electrode 21. The thin part 61 and the thin part 62 were formed on each of the inner winding side positive electrode active material layer 21B1 and the outer winding side positive electrode active material layer 21B2 each provided on the positive electrode current collector 21A by selectively performing laser ablation. Note that, in Example 6-1, the width of each of the thick parts 71, 72, 74, and 75 in the W direction was set to 6 mm that corresponded to 10% of the entire width of 60 mm of the positive electrode covered region 211 in the W direction.

### Comparative Example 1

The thin part 61 was formed in neither the inner winding side positive electrode active material layer 21B1 nor the outer winding side positive electrode active material layer 21B2 provided on the positive electrode current collector 21A, and the inner winding side positive electrode active material layer 21B1 and the outer winding side positive electrode active material layer 21B2 each had a uniform thickness throughout. Except for the above-described point, the secondary battery of Comparative example 1 was fabricated in a similar manner to Example 1-1.

### Comparative Example 2

The thin part 61 was formed on each of the inner winding side positive electrode active material layer 21B1 and the outer winding side positive electrode active material layer 21B2 each provided on the positive electrode current collector 21A. The thin part 61 extended over the entire positive electrode covered region 211 in the W direction. In other words, neither of the thick parts 71 and 72 was provided. Except for the above-described point, the secondary battery of Comparative example 2 was fabricated in a similar manner to Example 1-1.

### [Evaluation of Battery Characteristic]

Each of the secondary batteries of Examples 1-1 to 1-15, 2-1 to 2-4, 3-1 to 3-4, 4-1 to 4-4, and 5-1 to 5-3, and Comparative examples 1 and 2 obtained as described above was examined in terms of each of presence or absence of defective winding, a short-circuit occurrence rate after initial cycle of charging and discharging, a deformation amount of positive electrode after charging and discharging cycle, and a short-circuit occurrence rate after charging and discharging cycle. The results are presented in Tables 1 to 4.

TABLE 1

| | | | | After charging and | |
|---|---|---|---|---|---|
| | | | | discharging cycle | |
| | | | | Deformation | |
| | | | After initial | amount of | |
| | | | cycle of | positive | |
| | Width of thick part of | | charging and | electrode | |
| | positive electrode | | discharging | (middle | |
| | (first thick | Defective | Short-circuit | part/winding | Short-circuit |
| | part:second thick | winding | occurrence | center side | occurrence |
| | part:entire width) | [ppm] | rate [ppm] | edge) [μm] | rate [%] |
| Example 1-1 | Only at location | 0 | 0 | 47/24 | 0 |
| | covered with | | | | |
| | insulating layer | | | | |
| Example 1-2 | 10%:0%:100% | 0 | 0 | 45/24 | 0 |
| Example 1-3 | 20%:0%:100% | 0 | 0 | 45/25 | 0 |
| Example 1-4 | 33%:0%:100% | 0 | 0 | 48/48 | 0 |
| Example 1-5 | 50%:0%:100% | 0 | 0 | 65/75 | 0 |
| Example 1-6 | 0%:10%:100% | 0 | 0 | 45/24 | 0 |
| Example 1-7 | 0%:20%:100% | 0 | 0 | 45/24 | 0 |
| Example 1-8 | 0%:33%:100% | 0 | 0 | 48/48 | 0 |
| Example 1-9 | 0%:50%:100% | 0 | 0 | 65/76 | 0 |
| Example 1-10 | 5%:5%:100% | 0 | 0 | 42/24 | 0 |
| Example 1-11 | 10%:10%:100% | 0 | 0 | 43/24 | 0 |
| Example 1-12 | 15%:15%:100% | 0 | 0 | 43/25 | 0 |
| Example 1-13 | 25%:25%:100% | 0 | 0 | 45/25 | 0 |
| Example 1-14 | 33%:33%:100% | 0 | 0 | 49/50 | 0 |
| Example 1-15 | 40%:40%:100% | 0 | 0 | 68/80 | 0 |
| Comparative | No thin part | 0 | 0 | —/300 | 4 |
| example 1 | | | | | |
| Comparative | 0%:0%:100% | 0 | 300 | 95/98 | 2 |
| example 2 | | | | | |

TABLE 2

| | | | | | After charging and | |
|---|---|---|---|---|---|---|
| | | | | After initial | discharging cycle | |
| | Width of thick | | | cycle of | Deformation | |
| | part of positive | | | charging and | amount of | |
| | electrode (first | | | discharging | positive electrode | |
| | thick part:second | Difference | Defective | Short-circuit | (middle part/ | Short-circuit |
| | thick part:entire | in border | winding | occurrence | winding center | occurrence |
| | width) | position | [ppm] | rate [ppm] | side edge) [μm] | rate [%] |
| Example | Only at location | No | 0 | 0 | 47/24 | 0 |
| 1-1 | covered with | difference | | | | |
| | insulating layer | | | | | |
| Example | 10%:0%:100% | No | 0 | 0 | 45/24 | 0 |
| 1-2 | | difference | | | | |
| Example | 0%:10%:100% | No | 0 | 0 | 45/24 | 0 |
| 1-6 | | difference | | | | |
| Example | 10%:10%:100% | No | 0 | 0 | 43/24 | 0 |
| 1-11 | | difference | | | | |
| Example | Only position | Different | 0 | 0 | 23/12 | 0 |
| 2-1 | covered with | | | | | |
| | insulating layer | | | | | |
| Example | 10%:0%:100% | Different | 0 | 0 | 22/11 | 0 |
| 2-2 | | | | | | |
| Example | 0%:10%:100% | Different | 0 | 0 | 21/11 | 0 |
| 2-3 | | | | | | |
| Example | 10%:10%:100% | Different | 0 | 0 | 20/11 | 0 |
| 2-4 | | | | | | |

TABLE 3

| | | | | | | After charging and | |
|---|---|---|---|---|---|---|---|
| | | | | | After initial | discharging cycle | |
| | Width of thick | | | | cycle of | Deformation | |
| | part of positive | | | | charging and | amount of | |
| | electrode (first | | | | discharging | positive electrode | |
| | thick part:second | Difference | | Defective | Short-circuit | (middle part/ | Short-circuit |
| | thick part:entire | in border | Grooved | winding | occurrence | winding center | occurrence |
| | width) | position | part | [ppm] | rate [ppm] | side edge) [μm] | rate [%] |
| Example | Only at location | No | No | 0 | 0 | 47/24 | 0 |
| 1-1 | covered with | difference | provided | | | | |
| | insulating layer | | | | | | |
| Example | 10%:0%:100% | No | Not | 0 | 0 | 45/24 | 0 |
| 1-2 | | difference | provided | | | | |
| Example | 0%:10%:100% | No | Not | 0 | 0 | 45/24 | 0 |
| 1-6 | | difference | provided | | | | |
| Example | 10%:10%:100% | No | Not | 0 | 0 | 43/24 | 0 |
| 1-11 | | difference | provided | | | | |
| Example | Only position | No | Provided | 0 | 0 | 24/12 | 0 |
| 3-1 | covered with | difference | | | | | |
| | insulating layer | | | | | | |
| Example | 10%:0%:100% | No | Provided | 0 | 0 | 22/11 | 0 |
| 3-2 | | difference | | | | | |
| Example | 0%:10%:100% | No | Provided | 0 | 0 | 22/11 | 0 |
| 3-3 | | difference | | | | | |
| Example | 10%:10%:100% | No | Provided | 0 | 0 | 18/10 | 0 |
| 3-4 | | difference | | | | | |
| Example | Only position | Different | Provided | 0 | 0 | 10/8 | 0 |
| 4-1 | covered with | | | | | | |
| | insulating layer | | | | | | |
| Example | 10%:0%:100% | Different | Provided | 0 | 0 | 7/4 | 0 |
| 4-2 | | | | | | | |
| Example | 0%:10%:100% | Different | Provided | 0 | 0 | 7/4 | 0 |
| 4-3 | | | | | | | |
| Example | 10%:10%:100% | Different | Provided | 0 | 0 | 3/4 | 0 |
| 4-4 | | | | | | | |

TABLE 4

| | | | | | | After charging and | |
|---|---|---|---|---|---|---|---|
| | | | | | After initial | discharging cycle | |
| | Width of thick | | | | cycle of | Deformation | |
| | part of positive | | | | charging and | amount of | |
| | electrode (first | | | | discharging | positive electrode | |
| | thick part:second | | | Defective | Short-circuit | (middle part/ | Short-circuit |
| | thick part:entire | | Grooved | winding | occurrence | winding center | occurrence |
| | width) | Thin part | part | [ppm] | rate [ppm] | side edge) [μm] | rate [%] |
| Example | Only at location | Both | Not | 0 | 0 | 47/24 | 0 |
| 1-1 | covered with | sides | provided | | | | |
| | insulating layer | | | | | | |
| Example | 10%:10%:100% | Both | Not | 0 | 0 | 43/24 | 0 |
| 1-11 | | sides | provided | | | | |
| Example | 10%:10%:100% | Both | Provided | 0 | 0 | 18/10 | 0 |
| 3-4 | | sides | | | | | |
| Example | Only position | One side | Not | 0 | 0 | 40/23 | 0 |
| 5-1 | covered with | | provided | | | | |
| | insulating layer | | | | | | |
| Example | 10%:10%:100% | One side | Not | 0 | 0 | 30/18 | 0 |
| 5-2 | | | provided | | | | |
| Example | 10%:10%:100% | One side | Provided | 0 | 0 | 22/12 | 0 |
| 5-3 | | | | | | | |

In addition, each of the secondary batteries of Examples 1-11 and 6-1 was examined in terms of a short-circuit occurrence rate after high-temperature storage. The results are presented in Table 5. Note that, the secondary battery of Example 6-1 was also examined in terms of presence or absence of defective winding and the short-circuit occurrence rate after charging and discharging cycle.

TABLE 5

| | | | | | | | After storage |
|---|---|---|---|---|---|---|---|
| | | | | | | After | at high |
| | Width of thick | | | | | charging and | temperature |
| | part of positive | | | | | discharging | Short-circuit |
| | electrode (first | | | | | cycle | occurrence |
| | thick part:second | Thin part | | | Defective | Short-circuit | rate [%] |
| | thick part:entire | Inner end | Outer end | Grooved | winding | occurrence | (Number of |
| | width) | part | part | part | [ppm] | rate [ppm] | samples: 20) |
| Example | 10%:10%:100% | Provided | Not | Not | 0 | 0 | 10 |
| 1-11 | | | provided | provided | | | |
| Example | 10%:10%:100% | Provided | Provided | Not | 0 | 0 | 0 |
| 6-1 | | | | provided | | | |

### [Presence or Absence of Defective Winding]

The electrode wound body 20 of each of the secondary batteries was evaluated in terms of whether a physical short circuit occurred in a state where the electrolytic solution had not been injected into the electrode wound body 20. For the evaluation, the electrode wound body 20 of each of the secondary batteries was subjected to a high potential test (HPT). Upon conducting the HPT, a reference value of an insulation resistance was set to 0.2 kV. The number of samples was 10,000.

### [Short-Circuit Occurrence Rate After Initial Cycle of Charging and Discharging]

Presence or absence of a short circuit caused, for example, due to mixing of electrically conductive powder such as metal was determined based on presence or absence of heat generation after initial cycle of charging and discharging. The number of samples was 10,000.

### [Deformation Amount of Positive Electrode After Charging and Discharging Cycle]

Based on a computed tomography (CT) image, measured was an amount of projection of the positive electrode in the radial direction of the electrode wound body 20, caused in a middle part of the electrode wound body 20, i.e., a region including the borders 21B1K and 21B2K between the thin part 61 and the thick part 73 and the vicinity thereof, and in a region, of the electrode wound body 20, including the winding center side edge 21E1 and the vicinity thereof. The number of samples was 100. For example, the cycle test was performed with the following test conditions.

### [Cycle Test Conditions]

(1) Ambient temperature at which the test was performed: 23° C.
(2) Charge conditions: Constant current and constant voltage (CC-CV) charging was performed. Charging was performed with a constant current of 10 A to a voltage of 4.2 V, following which charging was performed with a constant voltage of 4.2 V. A cutoff current was set to 1 A.
(3) Rest time after charging: 60 minutes.
(4) Discharge conditions: Constant current (CC) discharging was performed with a constant current of 50 A. A cutoff voltage was set to 2 V, or discharging was stopped when a temperature reached 85° C.
(5) Rest after discharging: A rest was taken until a battery surface temperature fell below 50° C.
(6) Number of cycles: 100 cycles.

### [Short-Circuit Occurrence Rate After Charging and Discharging Cycle]

Each of the secondary batteries was subjected to a cycle test with the above-described test conditions. Thereafter, each of the secondary batteries was stored in an environment at 25° C. for one week. After the storage, if a voltage drop of 4.1 V or more was observed, it was determined that a short circuit had occurred.

### [Short-Circuit Occurrence Rate After High-Temperature Storage]

Each of the secondary batteries was fully charged. Each of the secondary batteries was charged with a constant current of 0.2 C until a voltage reached 4.2 V, and was thereafter charged with a constant voltage of 4.2 V. A cutoff current was set to 15 mA. Thereafter, each of the secondary batteries was stored in a thermostatic chamber at 60° C. for 60 days. Thereafter, a voltage of each of the secondary batteries was measured. If the voltage was found to have dropped below 4 V, it was determined that a short circuit had occurred. The number of samples was 20.

As indicated in each of Tables 1 to 4, in each of the secondary batteries of Examples 1-1 to 1-15, 2-1 to 2-4, 3-1 to 3-4, 4-1 to 4-4, and 5-1 to 5-3, none of the defective winding, the short circuit after initial cycle of charging and discharging, and the short circuit after charging and discharging cycle occurred. In contrast, in Comparative example 1, the short circuit after charging and discharging cycle occurred at a rate of 4%, that is, four samples out of 100 samples. In addition, in Comparative example 2, the short circuit after initial cycle of charging and discharging occurred at a rate of 300 ppm and the short circuit after charging and discharging cycle occurred at a rate of 2%, that is, two samples out of 100 samples.

As presented in Table 5, the short circuit after high-temperature storage occurred at a rate of 10% in Example 1-11, that is, two samples out of 20 samples. In contrast, the short circuit after high-temperature storage did not occur in Example 6-1, that is, zero samples out of 20 samples.

The results described above demonstrated that the secondary battery of an embodiment of the present disclosure made it possible to achieve further superior reliability. In addition, it was found that it was possible to further improve the safety by providing both the thin part in the vicinity of the winding center side edge of the electrode wound body and the thin part in the vicinity of the winding outer periphery side edge of the electrode wound body.

Although the present disclosure has been described hereinabove including with reference to embodiments including modification examples, a configuration of any embodiment of the present disclosure is not limited to the configurations described in relation to embodiments including modification examples, and is therefore modifiable in a variety of ways. For example, the thin part 61 serving as the “first thin part” may be positioned to be in contact with the winding center side edge 21E1 of the positive electrode 21. However, an embodiment of the present disclosure is not limited to the above-described configuration. In an embodiment, the first thin part, e.g., the thin part 61, may be provided at a location, in the positive electrode 21, away from the winding center side edge 21E1. Similarly, the thin part 62 serving as the “second thin part” does not necessarily have to be brought into contact with the winding outer periphery side edge 21E2 of the positive electrode 21. In an embodiment, the second thin part, e.g., the thin part 62, may be provided at a location, in the positive electrode 21, away from the winding outer periphery side edge 21E2.

For example, the description has been given of the case where the electrode reactant is lithium; however, the electrode reactant is not particularly limited. In an embodiment, the electrode reactant may be another alkali metal such as sodium or potassium. In an embodiment, the electrode reactant may be an alkaline earth metal such as beryllium, magnesium, or calcium, as described above. In an embodiment, the electrode reactant may be another light metal such as aluminum.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.

(1)

A secondary battery including:
an electrode wound body including a stacked body and having a through hole, the stacked body including a positive electrode, a negative electrode, and a separator and being wound along a longitudinal direction of the stacked body, the through hole being provided through the electrode wound body in a width direction orthogonal to the longitudinal direction; and
an outer package can containing the electrode wound body, in which
the positive electrode includes
   a positive electrode active material layer extending in both the longitudinal direction and the width direction,
   a positive electrode current collector including a positive electrode covered region and a positive electrode exposed region, the positive electrode covered region being covered with the positive electrode active material layer, the positive electrode exposed region being not covered with the positive electrode active material layer and extending in the width direction from the positive electrode active material layer, and
   an insulating layer extending in the longitudinal direction along a first edge of the positive electrode active material layer, the first edge being located at a border between the positive electrode covered region and the positive electrode exposed region, and
the positive electrode active material layer includes a first thin part and a first thick part, the first thick part having a thickness greater than a thickness of the first thin part and being adjacent to the first thin part in the width direction.
   (2)

The secondary battery according to (1), in which the first thin part includes a winding center side edge of the positive electrode in the longitudinal direction.

(3)

The secondary battery according to (1) or (2), in which the first thick part is positioned between the first thin part and the insulating layer.

(4)

The secondary battery according to (3), in which the first thick part is in contact with the insulating layer.

(5)

The secondary battery according to any one of (1) to (4), in which
the positive electrode active material layer further includes a second thick part positioned on an opposite side to the first thick part in the width direction, and
the second thick part has a thickness greater than the thickness of the first thin part.
   (6)

The secondary battery according to (2), in which
the positive electrode active material layer further includes a third thick part positioned on an opposite side of the first thin part to the winding center side edge in the longitudinal direction, and
the third thick part has a thickness greater than the thickness of the first thin part.
   (7)

The secondary battery according to any one of (1) to (6), in which
the positive electrode current collector includes an inward surface and an outward surface, the inward surface facing toward a winding center side of the electrode wound body, the outward surface facing toward an outer side opposite to the winding center side of the electrode wound body, and
each of the first thick part and the first thin part is provided on each of the inward surface and the outward surface of the positive electrode current collector.
   (8)

The secondary battery according to (6) or (7), in which
the positive electrode current collector includes an inward surface and an outward surface, the inward surface facing toward a winding center side of the electrode wound body, the outward surface facing toward an outer side opposite to the winding center side of the electrode wound body,
the positive electrode active material layer includes a first positive electrode active material layer and a second positive electrode active material layer, the first positive electrode active material layer being provided on the inward surface of the positive electrode current collector, the second positive electrode active material layer being provided on the outward surface of the positive electrode current collector,
each of the first positive electrode active material layer and the second positive electrode active material layer includes the first thin part, the first thick part, and the third thick part, and
a first length and a second length are different from each other, the first length being a length from the winding center side edge of the positive electrode in the longitudinal direction to a position of a first border between the first thin part of the first positive electrode active material layer and the third thick part of the first positive electrode active material layer, the second length being a length from the winding center side edge of the positive electrode in the longitudinal direction to a position of a second border between the first thin part of the second positive electrode active material layer and the third thick part of the second positive electrode active material layer.
   (9)

The secondary battery according to any one of (1) to (8), in which the positive electrode active material layer further includes a grooved part between the third thick part and the first thin part.

(10)

The secondary battery according to any one of (1) to (9), in which
the positive electrode active material layer further includes a second thin part on an opposite side of the third thick part to the first thin part, and
the second thin part has a thickness smaller than the thickness of the third thick part.
   (11)

The secondary battery according to any one of (1) to (10), further including a positive electrode current collector plate and a negative electrode current collector plate that are opposed to each other with the electrode wound body interposed between the positive electrode current collector plate and the negative electrode current collector plate in the width direction, in which
the electrode wound body includes a first end face and a second end face, the first end face facing the positive electrode current collector plate in the width direction, the second end face facing the negative electrode current collector plate in the width direction.
   (12)

The secondary battery according to (11), in which the first end face includes an edge part, of the positive electrode exposed region, that is bent toward the through hole with the electrode wound body being wound.

(13)

The secondary battery according to (11) or (12), in which all or a part of the positive electrode exposed region is included in the first end face and coupled to the positive electrode current collector plate.

(14)

The secondary battery according to any one of (11) to (13), in which
the negative electrode includes
   a negative electrode active material layer extending in both the longitudinal direction and the width direction, and
   a negative electrode current collector including a negative electrode covered region and a negative electrode exposed region, the negative electrode covered region being covered with the negative electrode active material layer, the negative electrode exposed region being not covered with the negative electrode active material layer and extending in the width direction from the negative electrode active material layer, and
the second end face includes an edge part, of the negative electrode exposed region, that is bent toward the through hole with the electrode wound body being wound.
   (15)

The secondary battery according to (14), in which all or a part of the negative electrode exposed region is included in the second end face and coupled to the negative electrode current collector plate.

(16)

The secondary battery according to any one of (11) to (15), further including a cover part coupled to the positive electrode current collector plate, in which
the outer package can includes a bottom part and a wall part, the wall part standing in the width direction along an outer edge of the bottom part, the wall part surrounding the electrode wound body, the wall part including an open end part through which the electrode wound body is passable, the open end part being on an opposite side to the bottom part, and
the cover part closing the open end part of the outer package can.
   (17)

The secondary battery according to (16), in which
the positive electrode current collector plate is positioned between the cover part and the first end face, and
the negative electrode current collector plate is positioned between the bottom part of the outer package can and the second end face.
   (18)

A battery pack including:
the secondary battery according to any one of (1) to (17);
a processor configured to control the secondary battery; and
an outer package body containing the secondary battery.

According to a secondary battery of an embodiment of the present disclosure and a battery pack including the secondary battery of at least an embodiment of the present disclosure, a positive electrode active material layer includes a first thin part. This helps to suppress concentration of stress inside an outer package can occurring due to swelling of a negative electrode. In addition, the positive electrode active material layer includes a first thick part adjacent to the first thin part. This makes it possible to effectively prevent displacement of a separator positioned between a positive electrode and the negative electrode. This helps to prevent a short circuit between the positive electrode and the negative electrode and thereby achieve superior reliability.

Note that effects of an embodiment of the present disclosure are not necessarily limited to the example effects described above and may include any of a series of effects described herein in relation to an embodiment of the present disclosure including the modification examples thereof.

Although the present disclosure has been described hereinabove in terms of an embodiment including modification examples, the present disclosure is not limited thereto. It should be appreciated that variations may be made in the described embodiments including modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive. As used in this specification and the appended claims, the singular forms “a,” “an,” and “the” include, especially in the context of the claims, are to be construed to cover both the singular and the plural, unless otherwise indicated herein or clearly contradicted by context. Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term “substantially”, “approximately”, “about”, and its variants having the similar meaning thereto are defined as being largely but not necessarily wholly what is specified as understood by one of ordinary skill in the art. The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked body and having a through hole, the stacked body including a positive electrode, a negative electrode, and a separator and being wound along a longitudinal direction of the stacked body, the through hole being provided through the electrode wound body in a width direction orthogonal to the longitudinal direction; and
an outer package can containing the electrode wound body, wherein
the positive electrode includes
a positive electrode active material layer extending in both the longitudinal direction and the width direction,
a positive electrode current collector including a positive electrode covered region and a positive electrode exposed region, the positive electrode covered region being covered with the positive electrode active material layer, the positive electrode exposed region being not covered with the positive electrode active material layer and extending in the width direction from the positive electrode active material layer, and
an insulating layer extending in the longitudinal direction along a first edge of the positive electrode active material layer, the first edge being located at a border between the positive electrode covered region and the positive electrode exposed region, and
the positive electrode active material layer includes a first thin part and a first thick part, the first thick part having a thickness greater than a thickness of the first thin part and being adjacent to the first thin part in the width direction.

2. The secondary battery according to claim 1, wherein the first thin part includes a winding center side edge of the positive electrode in the longitudinal direction.

3. The secondary battery according to claim 1, wherein the first thick part is positioned between the first thin part and the insulating layer.

4. The secondary battery according to claim 3, wherein the first thick part is in contact with the insulating layer.

5. The secondary battery according to claim 1, wherein
the positive electrode active material layer further includes a second thick part positioned on an opposite side to the first thick part in the width direction, and
the second thick part has a thickness greater than the thickness of the first thin part.

6. The secondary battery according to claim 2, wherein
the positive electrode active material layer further includes a third thick part positioned on an opposite side of the first thin part to the winding center side edge in the longitudinal direction, and
the third thick part has a thickness greater than the thickness of the first thin part.

7. The secondary battery according to claim 1, wherein
the positive electrode current collector includes an inward surface and an outward surface, the inward surface facing toward a winding center side of the electrode wound body, the outward surface facing toward an outer side opposite to the winding center side of the electrode wound body, and
each of the first thick part and the first thin part is provided on each of the inward surface and the outward surface of the positive electrode current collector.

8. The secondary battery according to claim 6, wherein
the positive electrode current collector includes an inward surface and an outward surface, the inward surface facing toward a winding center side of the electrode wound body, the outward surface facing toward an outer side opposite to the winding center side of the electrode wound body,
the positive electrode active material layer includes a first positive electrode active material layer and a second positive electrode active material layer, the first positive electrode active material layer being provided on the inward surface of the positive electrode current collector, the second positive electrode active material layer being provided on the outward surface of the positive electrode current collector,
each of the first positive electrode active material layer and the second positive electrode active material layer includes the first thin part, the first thick part, and the third thick part, and
a first length and a second length are different from each other, the first length being a length from the winding center side edge of the positive electrode in the longitudinal direction to a position of a first border between the first thin part of the first positive electrode active material layer and the third thick part of the first positive electrode active material layer, the second length being a length from the winding center side edge of the positive electrode in the longitudinal direction to a position of a second border between the first thin part of the second positive electrode active material layer and the third thick part of the second positive electrode active material layer.

9. The secondary battery according to claim 6, wherein the positive electrode active material layer further includes a grooved part between the third thick part and the first thin part.

10. The secondary battery according to claim 6, wherein
the positive electrode active material layer further includes a second thin part on an opposite side of the third thick part to the first thin part, and
the second thin part has a thickness smaller than the thickness of the third thick part.

11. The secondary battery according to claim 1, further comprising a positive electrode current collector plate and a negative electrode current collector plate that are opposed to each other with the electrode wound body interposed between the positive electrode current collector plate and the negative electrode current collector plate in the width direction, wherein
the electrode wound body includes a first end face and a second end face, the first end face facing the positive electrode current collector plate in the width direction, the second end face facing the negative electrode current collector plate in the width direction.

12. The secondary battery according to claim 11, wherein the first end face comprises an edge part, of the positive electrode exposed region, that is bent toward the through hole with the electrode wound body being wound.

13. The secondary battery according to claim 11, wherein all or a part of the positive electrode exposed region is included in the first end face and coupled to the positive electrode current collector plate.

14. The secondary battery according to claim 11, wherein
the negative electrode includes
a negative electrode active material layer extending in both the longitudinal direction and the width direction, and
a negative electrode current collector including a negative electrode covered region and a negative electrode exposed region, the negative electrode covered region being covered with the negative electrode active material layer, the negative electrode exposed region being not covered with the negative electrode active material layer and extending in the width direction from the negative electrode active material layer, and
the second end face comprises an edge part, of the negative electrode exposed region, that is bent toward the through hole with the electrode wound body being wound.

15. The secondary battery according to claim 14, wherein all or a part of the negative electrode exposed region is included in the second end face and coupled to the negative electrode current collector plate.

16. The secondary battery according to claim 11, further comprising a cover part coupled to the positive electrode current collector plate, wherein
the outer package can includes a bottom part and a wall part, the wall part standing in the width direction along an outer edge of the bottom part, the wall part surrounding the electrode wound body, the wall part including an open end part through which the electrode wound body is passable, the open end part being on an opposite side to the bottom part, and
the cover part closing the open end part of the outer package can.

17. The secondary battery according to claim 16, wherein
the positive electrode current collector plate is positioned between the cover part and the first end face, and
the negative electrode current collector plate is positioned between the bottom part of the outer package can and the second end face.

18. A battery pack comprising:
a secondary battery;
a processor configured to control the secondary battery; and
an outer package body containing the secondary battery,
the secondary battery including
an electrode wound body including a stacked body and having a through hole, the stacked body including a positive electrode, a negative electrode, and a separator and being wound along a longitudinal direction of the stacked body, the through hole being provided through the electrode wound body in a width direction orthogonal to the longitudinal direction, and
an outer package can containing the electrode wound body, wherein
the positive electrode includes
a positive electrode active material layer extending in both the longitudinal direction and the width direction,
a positive electrode current collector including a positive electrode covered region and a positive electrode exposed region, the positive electrode covered region being covered with the positive electrode active material layer, the positive electrode exposed region being not covered with the positive electrode active material layer and extending in the width direction from the positive electrode active material layer, and
an insulating layer extending in the longitudinal direction along a first edge of the positive electrode active material layer, the first edge being located at a border between the positive electrode covered region and the positive electrode exposed region, wherein
the positive electrode active material layer includes a first thin part and a first thick part, the first thick part having a thickness greater than a thickness of the first thin part and being adjacent to the first thin part in the width direction.
